(19) United States
(12) Patent Application Publication
(10) Pub. No.: US 2026/0107107 A1
(43) Pub. Date: Apr. 16, 2026

(54) METHOD AND SYSTEM TOOL FOR CONTEXTUAL PLAYBACK AND GENERATION OF CONTENT ON A MOBILE DEVICE USING DATA FROM CONNECTED SENSORS AND EXTERNAL DATA SOURCES

(71) Applicant: David Hynds, Orlando, FL (US)

(72) Inventor: David Hynds, Orlando, FL (US)

(21) Appl. No.: 18/915,950

(22) Filed: Oct. 15, 2024

(51) Int. Cl. H04W 4/021; H04N 21/414

(52) U.S. Cl. CPC H04W 4/021; H04N 21/41407

(57) ABSTRACT

Method and system tool for contextual playback of existing media content on a mobile device or for generating new and complex musical, spoken word narrative, soundscape content, or any permutation thereof, alone or in combination, in real-time on a mobile device leveraging location and additional sensor data, external data sources, user preferences, user traits, and user programming.

### RELATED APPLICATIONS

This application claims priority to U.S. Provisional Patent Application No. 63/657,880, filed on Jun. 9, 2024, and U.S. Pat. No. 11,589,185, filed on Oct. 9, 2020. Both are incorporated herein by reference in their entireties, including any addenda, appendices, and attachments thereto, to the extent this application does not conflict with the present disclosure herein.

### BACKGROUND OF THE INVENTION

Existing solutions that play music and other media content through a mobile device are traditionally under direct control of the user. The selection of which content to play at any given time during device operation are manually chosen by the user, except in the case of functionality such as playing the next selection in a predefined sequential list of selections, playing a random selection from a predefined list of selections, playing content based on algorithms that measure historical user preferences, or playing content from a content streaming service with the content being selected by the service itself.

Additionally, mobile devices utilize data for various unrelated software functions based on multiple hardware sensors and software algorithms embedded within the mobile device or otherwise connected locally to the device, an example of which is location information provided by the mobile device manufacturer or by third party mapping services.

Therefore, a use case exists for a novel tool which drives the playback of existing media content or real-time generation of new media content using sensor data and external data sources to create an elevated user experience. Example use cases may include, but are not limited to: playing back existing media or generating new media for a child riding to school with a parent in an automobile based on the context of their commute; providing motivation for a marathon runner by playing music with specific style details when encountering specific challenges along a geographic route; executing a particular media content change for a commuter as their route transitions them onto a highway and they desire a corresponding experience; or providing a musical remedy to assist a user with or without a specific mental health condition by playing appropriate media to improve their mental wellness state based on context and user preferences.

### SUMMARY OF THE INVENTION

The present invention is directed towards a tool (“tool”) for merging the concepts of media content (“content”), information from one or a plurality of internal or connected sensors (“sensor group”), and information from one or a plurality of external data sources (“data source group”) into a single embodiment. The present invention comprises a programmable application (“app”) using the app software in combination with the mobile device and mobile device operating software (OS) for automatic contextual playback, manipulation, or generation of content based on data provided by the sensor group and the data source group.

As used herein, the term “experience” refers to a period of time during which the user of the tool uses the mobile device and is able to see or hear media content provided by the tool. The tool provides a platform to elevate the emotional impact and relevance of the experience by evaluating contextual cues such as the past, current, or projected future state of their environment, alongside complementary data, activities, user preferences, and user traits, to play or manipulate existing content, or generate new content that has purpose and meaning within the experience context or a broader context. This is well beyond the conventional functionality of media playback on a mobile device.

The invention employs four primary processing methods that leverage data from the sensor group and the data source group to customize experiences based on routes of travel, distance criteria, temporal criteria, or user wellness criteria. Each of these methods can be executed individually to provide the novel experience, or used together in any combination.

The tool utilizes mobile device location (i.e. the location of the user who is associated with the mobile device) as a primary sensor input, enabling functionality that goes beyond reacting to a single static location to control content and instead responds to dynamic changes in their traveling environment, to projected changes over time, or to a combination of both. This aspect allows for a travel route to be followed and a location to be reacted to upon arrival, and, in some embodiments, a location to be projected and acted upon based on a projected travel route and an anticipated destination. An additional aspect of the tool's location awareness allows for a user associated with a mobile device to manipulate their experience by moving purposefully within a traveling environment or adjusting their activities to intentionally experience different content. For example, as a user walks through a park or a backyard garden, their change in location can automatically play or generate certain desired music, spoken word, or soundscape content, or any permutation thereof, based on that user's knowledge of content that they previously experienced in that region of their environment. In this example, standing in one area of the garden might cue peaceful and relaxing sounds, while walking to another area of the garden could gently transition to upbeat, motivating music, allowing the user to influence their mood accordingly.

### BRIEF DESCRIPTION OF THE DRAWINGS

The present invention is illustrated by way of example, and not by way of limitation, in the figures of the accompanying drawings.

While aspects of the present invention will be described with reference to the details of the embodiments of the invention shown in the drawings (and some embodiments not shown in the drawings), these details are not intended to limit the scope of the invention.

FIG. 1A. illustrates the traveling environment in which the tool operates during a Journey that anticipates a destination.

FIG. 1B. illustrates the traveling environment in which the tool operates during a Journey that does not anticipate a destination.

FIG. 2. describes the components that provide contextual cues, generating the comprehensive context for the user experience.

FIG. 3. shows an embodiment of the tool flowchart illustrating the high-level functionality upon launching the software.

FIG. 4. shows an embodiment of the tool flowchart describing the functions involved when an action is being executed.

FIG. 5. shows an embodiment of the tool flowchart illustrating the functionality when fetching new content and related processes.

FIG. 6. shows an embodiment of the tool flowchart describing app software operation when continuing playback after completion of specific content.

FIG. 7. shows an embodiment of the tool flowchart illustrating the real-time generation of content by the tool as a part of the Level III functionality.

FIG. 8. (SS1) shows an embodiment of the tool home page during an active Journey.

FIG. 9. (SS2) shows an embodiment of the tool main menu choices.

FIG. 10. (SS3) shows an embodiment of the tool details view for an example Place previously defined by a user.

FIG. 11. (SS4) shows an embodiment of the tool edit view (upper screen portion) for an example Place being edited by a user.

FIG. 12. (SS5) shows an embodiment of the tool edit view (lower screen portion) for an example Place being edited by a user with additional preferences visible.

FIG. 13. (SS6) shows an embodiment of the tool time parameters for an example Event previously defined.

FIG. 14. (SS7) shows an embodiment of the tool Journey detail view, including its Places and Events and other configuration parameters.

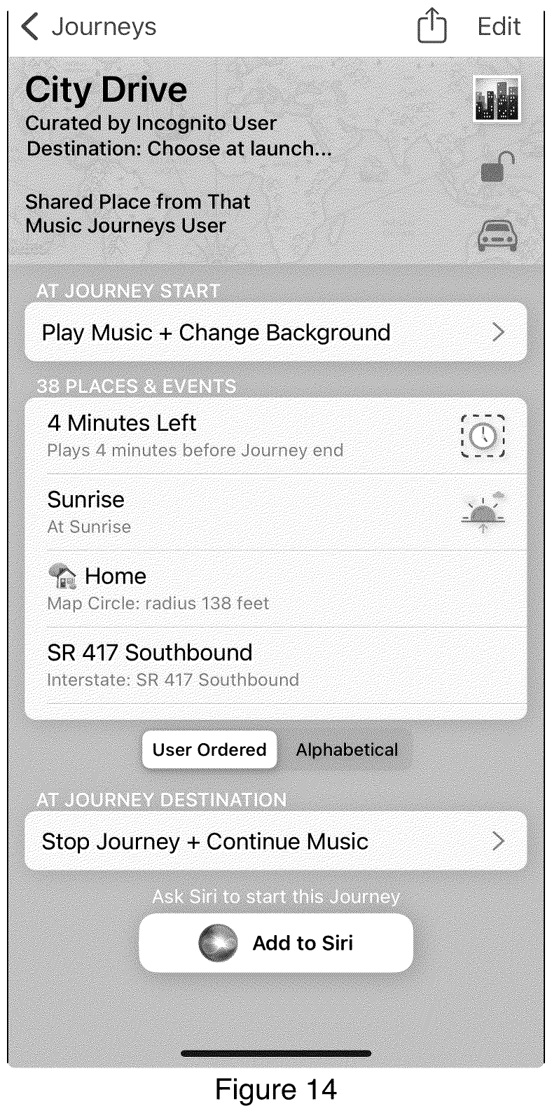

FIG. 15. (SS8) shows an embodiment of the tool Journey detail view including its Places and Events, and the capability to modify the expected order and other configuration parameters.

FIG. 16. (SS9) shows an embodiment of the tool Place Capture mechanism, where locations or routes can be captured as the user travels, and then saved as a new Journey.

FIG. 17. (SS10) shows an embodiment of the tool details available for a Journey name and mode of travel setup.

FIG. 18. (SS11) shows an embodiment of the tool details available for a Journey icon setup.

FIG. 19. (SS12) shows an embodiment of the tool details available for a Journey launch action.

FIG. 20. (SS13) shows an embodiment of the tool details available for a Journey Place and Event selection.

FIG. 21. (SS14) shows an embodiment of the tool (upper screen portion) containing specific user experience settings.

FIG. 22. (SS15) shows an embodiment of the tool (lower screen portion) containing specific user experience settings.

FIG. 23. (SS16) shows an embodiment of the tool containing Journey engine-related settings.

FIG. 24. (SS17) shows an embodiment of the tool containing Curator setup settings.

FIG. 25. (SS18) shows an embodiment of the tool containing the Map display view.

FIG. 26. (SS19) shows an embodiment of the tool of the Journey Charm details.

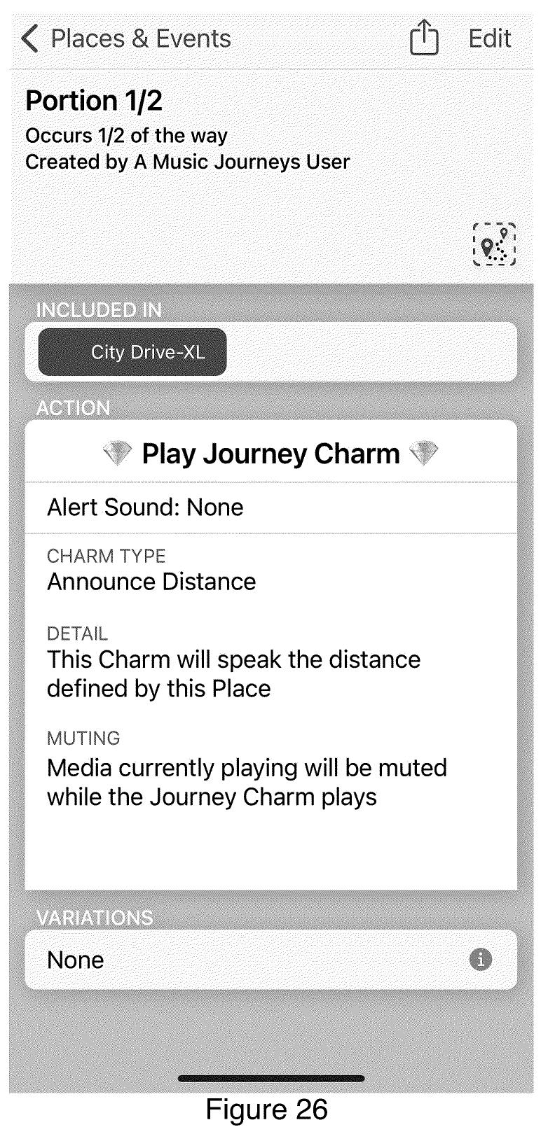

FIG. 27. (SS20) shows an embodiment of the tool of the setup for a Journey Event that triggers when a specific percentage of distance progress has been made toward the Journey's destination.

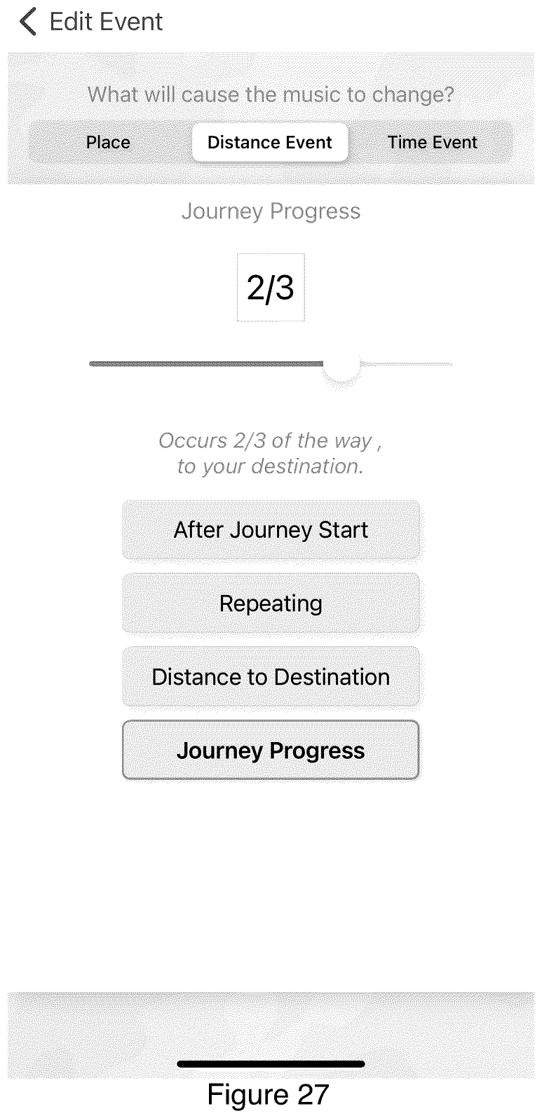

### DETAILED DESCRIPTION

The following description is not to be taken in a limiting sense but is made merely for the purpose of describing the general principles of exemplary embodiments; many additional embodiments of this invention are possible. It is understood that no limitation of the scope of the invention is thereby intended. The scope of the disclosure should be determined with reference to the Claims. Reference throughout this specification to “one embodiment,” “an embodiment,” or similar language means that a particular feature, structure, or characteristic that is described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

The invention is described with such embodiments, but the invention is not limited to any embodiment. The scope of the invention is limited only by the claims and the invention encompasses numerous alternatives, modifications, and equivalents. Several specific details are set forth in the following description to provide a thorough understanding of the invention. These details are provided for the purpose of example and the invention may be practiced according to the claims without some or all of these specific details. In general, the order of the steps of disclosed processes may be altered within the scope of the invention. A component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A tool (app, app tool, app software, app tool software are all used interchangeably herein to disclose the embodiments of the tool) is disclosed using software and location data for playback of content on a mobile device. A mobile device comprises any device that is made for portability, including but not limited to: a mobile phone, a tablet, a laptop computer, or a sound system or entertainment system embedded in a vehicle of any type. Improvements to data storage, processing and display technologies allow these devices to do nearly anything that had previously been traditionally done with larger personal computers. Some mobile devices are also known as handheld computers.

The term “content” (hereinafter referred to interchangeably as content or media content) as used herein comprises various forms of aural and visual communication medium, including, but not limited to: music, podcasts, audio books, soundscapes, sound effects, user-recorded audio tracks, device-generated spoken word narratives, device-generated music, device-generated soundscapes, or any permutation thereof, alone or in combination.

The term “sensor group” (hereinafter referred to interchangeably as ‘sensor group’ or ‘sensors’) as used herein denotes a collective of sensors contributing to the functionalities of the system. The sensor group may include various sensors, such as GPS receivers, Bluetooth receivers, cameras, microphones, timekeeping mechanisms, day-of-week indicators, speed, acceleration, directional sensors, altitude sensors, voice input used used as input to natural language processing algorithms and sentiment analysis algorithms, and user biometric sensors, among others. These sensors may be integrated directly into the mobile device or connected to it wirelessly or via cabling. Relationships between sensors within the sensor group can be viewed complementary, cooperative, or both. The sensor group is used in its entirety by the tool as a holistic snapshot and is evaluated based on current state or projected future state of all sensors within the sensor group.

The term “data source group” (hereinafter referred to interchangeably as ‘data source group,’ ‘data sources,’ or ‘external data sources’) as used herein refers to a collection of data sources that provides information for various functionalities of the system. Examples of data source types included in the data source group may encompass, but are not limited to: weather data relevant to the user's current or projected location, contextual data such as landmarks or historical information pertaining to locations along a projected route, and available content recommended or authorized for playback by caregivers, healthcare professionals, or other authorized individuals with user consent. It should be understood that the examples provided herein are illustrative and non-limiting, and the scope of the data source group encompasses other data sources not explicitly mentioned.

The term ‘soundscape’ as used herein refers to the acoustic environment or the collection of sounds that are present, expected to be present, or represents a new and alternate aural reality in a particular physical or virtual location at a given time. It encompasses all audible elements, including natural sounds (such as birdsong, wind, water), human-made sounds (such as traffic, machinery, voices), and any other sounds that contribute to the overall aural experience of a location.

Unless otherwise indicated, the drawings are intended to be read (e.g., arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightward”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate. Also, as used herein, terms such as “positioned on” or “supported on” mean positioned or supported on but not necessarily in direct contact with the surface.

The phrases “at least one,” “one or more,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. The terms “a” or “an” entity refers to one or more of that entity. As such, the terms “a” (or “an”), “one or more” and “at least one” can be used interchangeably herein.

Further, the described features, structures, or characteristics of the present disclosure may be combined in any suitable manner in one or more embodiments. In the Detailed Description, numerous specific details are provided for a thorough understanding of embodiments of the disclosure. One skilled in the relevant art will recognize, however, that the embodiments of the present disclosure can be practiced without one or more of the specific details, or with other methods, components, materials, and so forth. In other instances, well-known structures, materials, or operations are not shown or described in detail to avoid obscuring aspects of the present disclosure. Any alterations and further modifications in the illustrated devices, and such further application of the principles of the invention as illustrated herein are contemplated as would normally occur to one skilled in the art to which the invention relates.

For the purposes of promoting an understanding of the principles of the present invention, reference will now be made to the embodiments illustrated in the drawings and specific language will be used to describe the same, only as examples and not intended to be limiting.

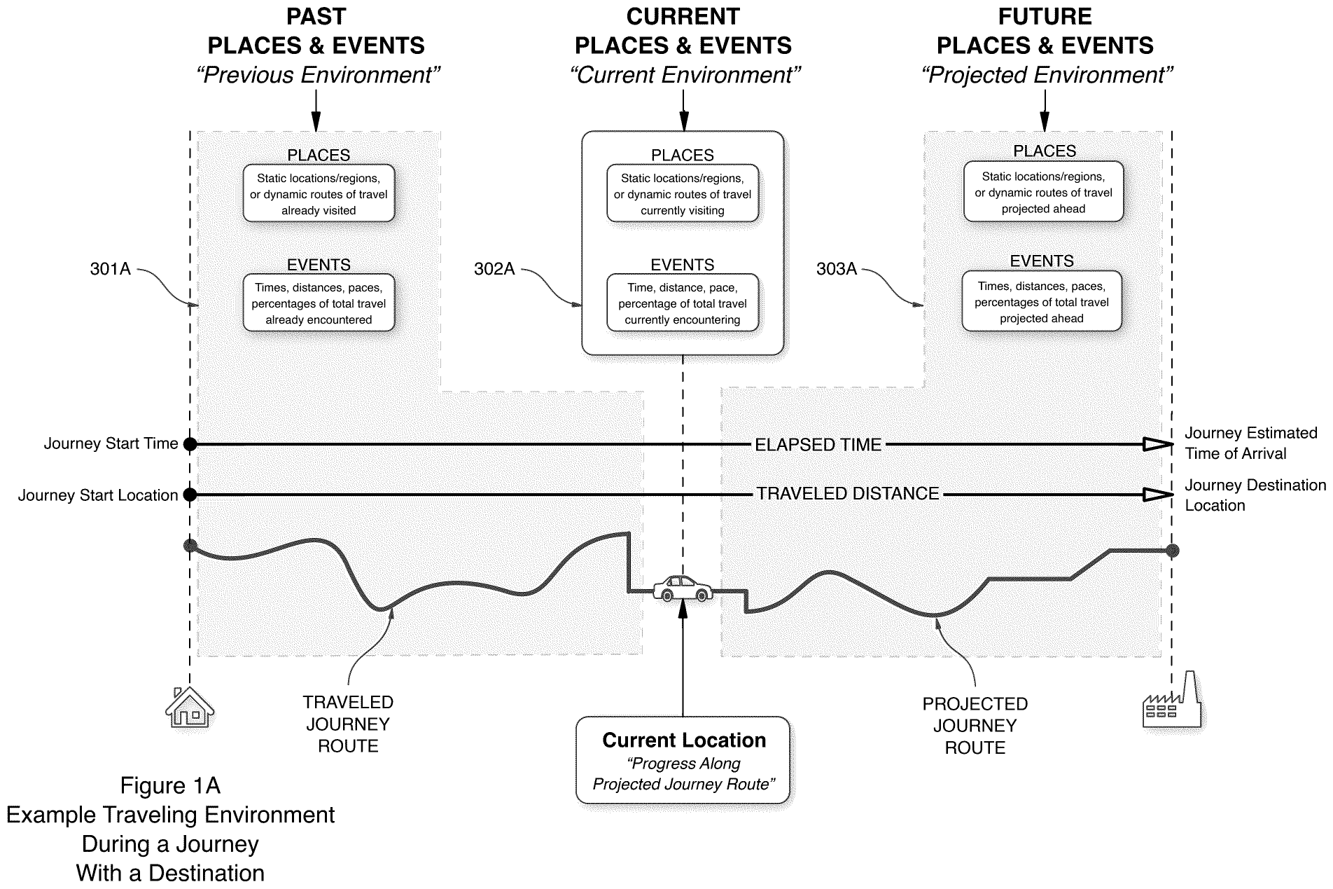

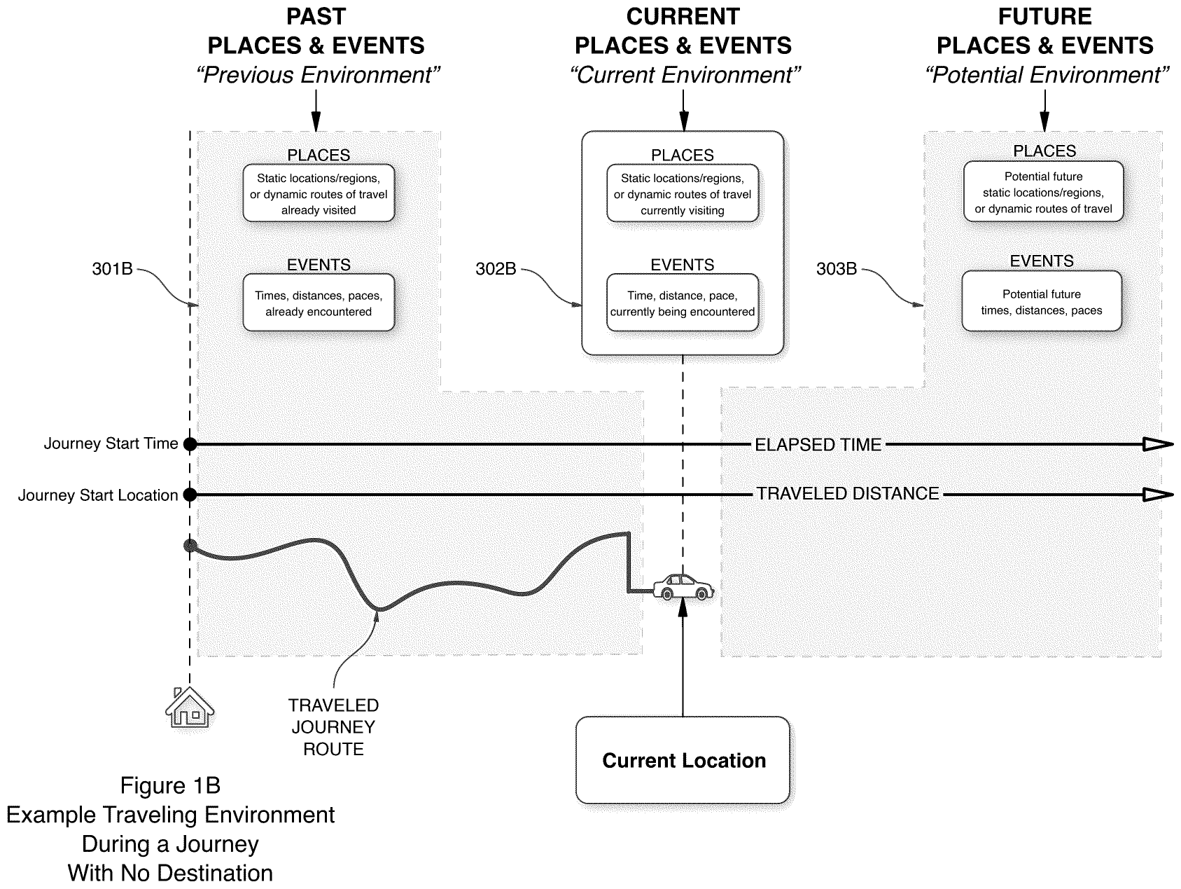

In some embodiments the present invention a foundational construct within the app software is that of a traveling environment (see FIGS. 1A, 1B). This environment collectively represents past (previous environments), 301A, 301B, current 302A, 302B, and projected future (potential environments) 303A, 303B, environments.

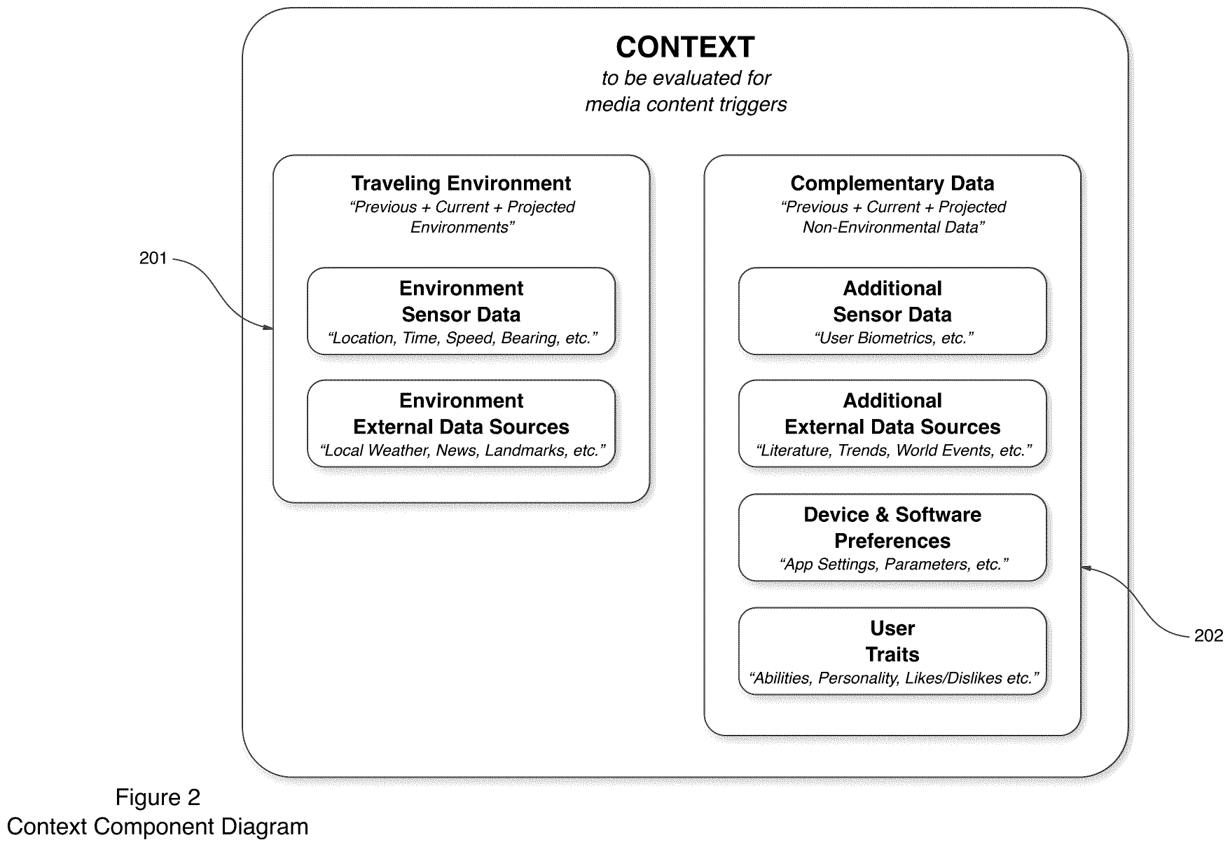

In some embodiments the present invention incorporates media content triggers responsive to contextual cues. These triggers may initiate playback of existing media content, adjust it dynamically, generate new media in real-time, dynamically adapt the new media generation process, or perform other actions. The cues are derived by the app software as a part of the overall context (see FIG. 2) of the user and the mobile device, comprising a traveling environment, 201, and complementary data, 202. Taken as the sum of all relevant contextual cues, context serves as the primary activator for the triggers that start, stop, or adjust the media content, or that perform other actions.

In some embodiments a specific type of media content trigger is referred to as a Place, 5, 3, 200. This trigger type is fundamentally driven by a static or dynamic definition of location, coupled with an optional definition of motion within the traveling environment (see FIGS. 1A, 1B). One type of a geographical definition is static, which can be circular, elliptical, rectangular, or polygonal in shape. Another type of a geographical definition can be dynamic, representing a defined route of travel over time. A defined route of travel such as a roadway, sidewalk, railway, subway, watercraft path, or trail includes not only the geographical definition in the form of multiple interconnected polylines or the like, along with a dynamic change in location over time, but also includes a definition of motion including speed, acceleration, and bearing. These geographical definitions can be chosen or created based on their meaning and purpose to the user, whether it be of personal significance such as a user's home, workplace, school, relative's home, or other personal location, or whether it be of locational significance such as a specific area that is differentiated from surrounding areas, a neighborhood, highway, trail, or other defined region, or whether it be of public significance such as a landmark, tourist attraction, or other publicly known location like a park or a beach.

In some embodiments a specific type of media content trigger is referred to as an Event, 5, 3, 200. This trigger type is optionally informed by a static or dynamic definition of location, and informed without exception by non-location and non-motion sensor data and external data sources within the traveling environment (see FIGS. 1A, 1B). Examples of Event triggers include, but are not limited to, elapsed time of the Journey, estimated time of arrival at a destination, repeating time interval, time of day, sunrise or sunset time, distance traveled in a Journey, distance to destination, repeating distance intervals, percentage or proportion of the total estimated distance to a destination traveled since the Journey start, traveling speed, bearing, traveling pace, or biometric parameter. The criteria used to implement these triggers can be based on a specific threshold or a threshold range.

In some embodiments of the present invention a destination can contain an associated payload that provides additional auditory or visual content, or general information that is pertinent to the destination itself or to an owner or a resident of the destination. A payload may contain items such as, but not limited to: specific media content; a spoken word announcement; a URL or other information packet provided by a destination business or individual for announcing, playing back specific media content, or displaying within the tool; or contact information for a resident of the destination for communicating, further comprising: a phone number or email for sending a pre-arrival text message; or a version of the tool installed on their phone which may provide messaging or other corresponding local media content actions.

In some embodiments of the present invention a graphical user interface (hereinafter referred to interchangeably as graphical interface or GUI) is presented directly within the tool on the mobile device or from an internet-based server that is directly related to and wholly a part of this invention, to create, define, modify, or delete a Place or Event, as well as to import a Place or Event as defined by another user, group, or business entity.

In some embodiments of the present invention the further capability is provided using the graphical interface for the user to collect Places or Events into groupings, known as Journeys 100, 101, to be selected and executed as a single data structure to provide a unique experience. The concept of a Journey allows the user, through the application software, to experience an otherwise novel content experience of their own definition, which can be created entirely by the user in the tool's GUI, imported from an online marketplace accessible through the tool, or directly provided by another individual, business, or other providing entity, where specific content is selected and played or otherwise manipulated based on information from the sensor group or the data source group. This provides the user with an immersive, contextual content experience connecting current environment and activities to the content available through the mobile device. A Journey can be launched by multiple methods such as, but not limited to, app preference settings that launch a Journey automatically upon startup, manual selection of a Journey by the user, by the user scanning a machine-readable code (oftentimes referred to as a “QR code”) that adheres to standard QR code structures, or by the user scanning a custom-designed functional variation on a graphical multidimensional barcode that is specific to the app software.

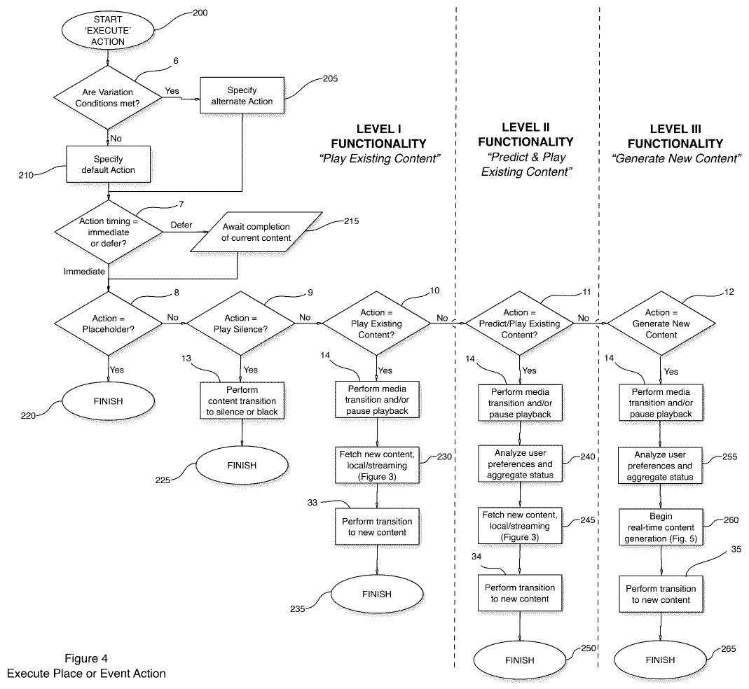

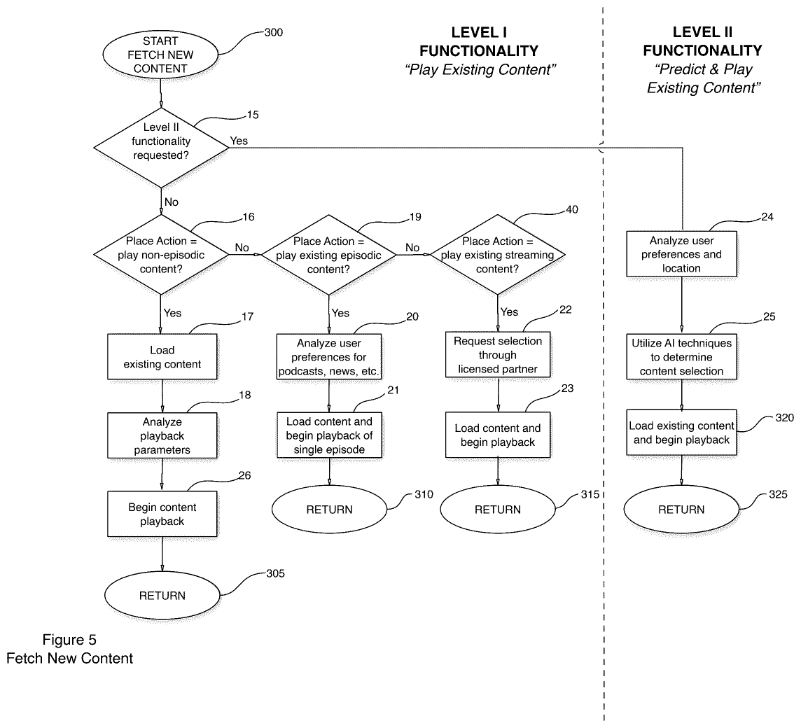

In some embodiments of the present invention primary object, referred to herein as “Level I” (see FIGS. 4, 5) functionality, comprising a method for programming an app and implementing the playback of custom recorded, assembled, or edited content, custom recorded content, previously purchased individual content, or content otherwise licensed by the user on the subject device based on location, time of day, day of the week, weather, or other input parameters. Location data can be provided by the mobile device using methods including, but not limited to, global positioning system data, Bluetooth beacons or other wireless positioning methods.

In some embodiments of the present invention a secondary object, referred to herein as “Level II” FIG. 4, FIG. 5 functionality, comprising a method for predicting and playing previously purchased individual content or content otherwise licensed by the user on the subject device, based on location parameters. Examples could include, but are not limited to, playing content evocative of a beach as the user device approaches the beach, rainy day music driven by weather data provided by a third-party Application Programming Interface (API), content appropriate for an evening mood due to the time of day, movie soundtracks when near a theatre, etc.

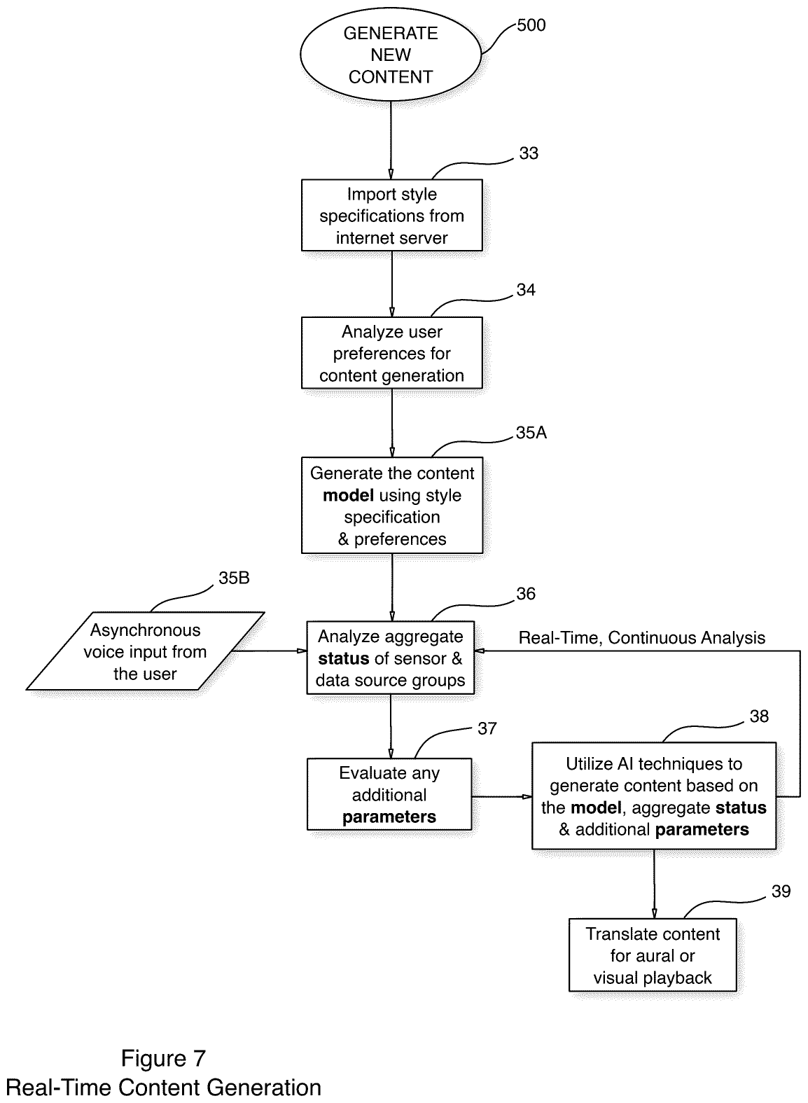

In some embodiments of the present invention another object, referred to herein as “Level III” functionality FIG. 4, FIG. 7 (block 500), comprising a method for generating and playing media containing complex musical, spoken word narrative, soundscape content, or any permutation thereof, alone or in combination, in real-time based on user preferences previously selected by the user, content style specifications, additional Place or Event parameters, sensor group information, or data source group information.

The embodiments of the present invention may be utilized individually, concurrently, or in any sequential combination.

The order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

Specific typical examples of the hardware/software are as follows, not intended to be limiting: processor(s) are suitable central processing unit (CPU) or neural processing unit (NPU) chips such as those manufactured by Apple, TSMC, Qualcomm, Intel, AMD, IBM, AT&T, ARM v7 64-bit, etc. The chips may be 32-bit, 64-bit or any other type of processor suitable for this application. Suitable software code and/or computer code/instructions used for practicing the invention may be—iOS: Swift, Objective-C, C, C++, Dart-Android: Java, C++, JavaScript, Dart, for example, or programmed in any language that is compatible with a mobile device. The device needs sufficient data storage for the amount and type of data desired by any of the embodiments disclosed herein. The hardware can be made by any manufacturer whose specifications are compatible to the hardware/software requirements disclosed above as examples, not intended to be limiting.

In some embodiments the app software is launched by the user (FIG. 1) in one of two ways: through standard touch actions as presented through the mobile device operating system, or through voice commands as facilitated by the mobile device operating system (OS).

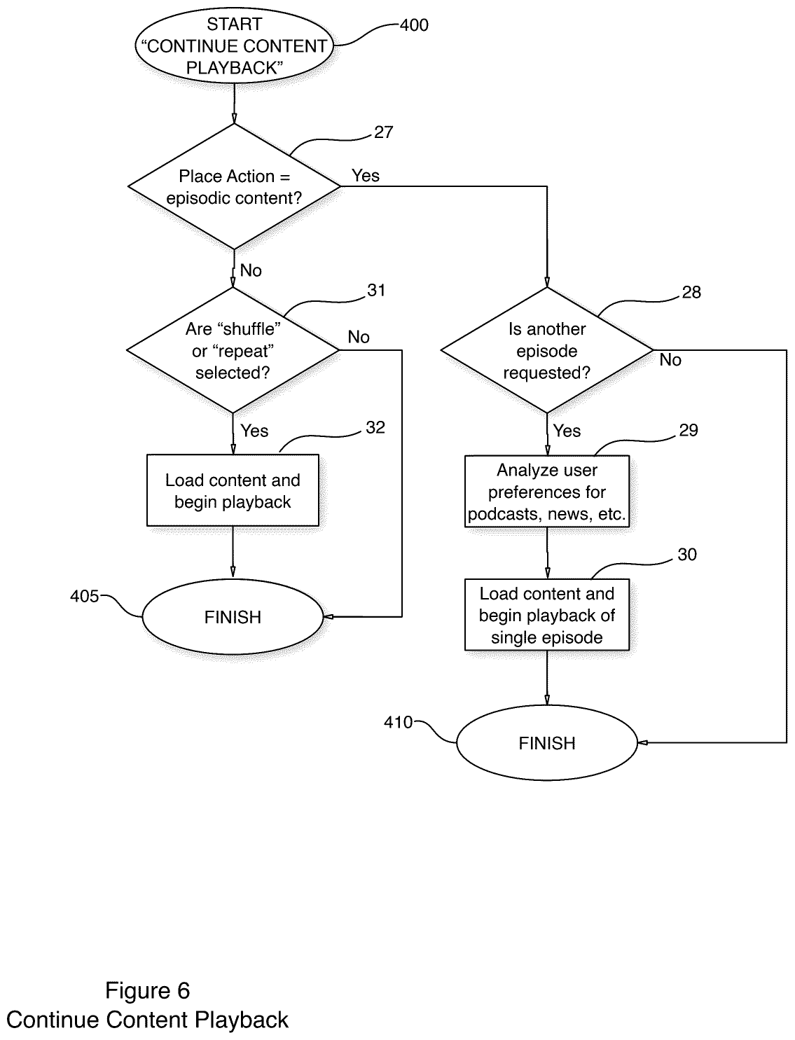

The initial state of the app software is determined by saved user preferences that control whether the app software starts up in Wander Mode 100 or within a predefined and valid Journey 100. If neither are present, the app software awaits additional user input in block 1 to determine the state and proceed (see FIG. 6).

“Wander Mode” is herein defined as a large, nonspecific Journey that can be configured by the user to include all Places or Events defined, or any subset thereof. The intent is to have a configuration that allows for contextual playback without anticipating a specific path or endpoint, such as general driving or traveling. This mode of operation anticipates neither a predefined route nor a predefined destination.

If Wander Mode is in effect upon app startup or becomes in effect through user selection, in block 2 the status of both the sensor group and the data source group of the mobile device are assessed as the primary inputs to the app software engine to determine an aggregate status. As referenced in block 3, if the aggregate status matches one or a plurality or status triggers as previously defined for a Place or Event by the user, the appropriate Place or Event action is called. Wander Mode can be configured by the user to include all Places and Events previously defined, or any subset thereof.

Likewise, if a valid Journey is in effect upon app startup or becomes in effect through user selection, in block 4 the status of both the sensor group and the data source group of the mobile device are assessed as the primary inputs to the app software engine to determine an aggregate status. As referenced in block 5, if the aggregate status matches one or a plurality or status triggers as previously defined for a Place or Event by the user, the appropriate Place or Event action is called. “Journeys” are hereby defined as collections of Places and Events previously defined by the user.

In some embodiments the processes for initially defining the data structures for Places, Events, and Journeys are described in subsequent detail within this document.

In some embodiments execution of a default action (FIG. 4) or of a variation action 6, 205 can be programmed or defined by the user through the GUI directly within the tool on the mobile device or from an internet-based server that is directly related to and wholly a part of this invention. This default action is executed when a valid location is recognized by the app software, absent any variations.

In some embodiments a variation triggers an alternate action for a Place or Event that will take priority over a default action and be executed by the app software if one of more predefined status parameters are met (block 6). A single Place or Event may have none, one, or a plurality of variations contained within its definition, in addition to its default action. The predefined parameters that may be used individually or in conjunction with one another in any given variation include, but are not limited to, time of day, weather, day of the week, round trip return to a Place, or the Journey that is being executed, for example.

In some embodiments the user can select whether a primary Place or Event action or variation Place or Event action is to occur immediately or be deferred 7 until the currently playing content is complete. In block 7 the app software will wait, if appropriate, before commencing action execution.

In some embodiments, actions, for example, not intended to be limiting, can take multiple basic forms: Journey placeholder, play silence, play user-recorded content, play existing licensed content, predict and play existing licensed content, or generate new musical, narrative, or soundscape content.

The placeholder form in block 8 is used simply as a placeholder for the user when defining a Place or Event. It triggers no actual playback action, but allows for a Place or Event to be fully defined otherwise in terms of sensor group status or data source information.

The play silence form in block 9 provides complete silence, useful for providing a desired buffer between Places and Events or to allow for content to cease playing when the user approaches a location where a quiet state is desired.

The play existing content form in block 10 is the most common form for a typical user, where music, episodic content, a radio channel, custom recorded tracks, narrative spoken words, soundscapes, sound effects, or any permutation thereof, alone or in combination are played.

The predict and play existing content form in block 11 is similar to block 10, with the fundamental difference being that the user has opted for this action to allow the app software to intelligently analyze user preferences and aggregate status of all relevant data in block 240 and select content accordingly. Example use cases could be, but are not limited to, proximity to a historic government building causing the tool to select patriotic music or generate new corresponding spoken word content, a public facility such as a beach triggering content appropriate for that area, an event underway such as a baseball game playing baseball-themed selections, and the like. The selection parameters, appropriate to the content type but described with music herein, to be used and their relative weighting are determined during Place or Event programming and include, but are not limited to, genre of music, words within the title or artist of the music, or prominent lyrics within the music. Additional use cases could be, but are not limited to, Places, Events, or Journeys automatically downloaded to the app software in the background from third-party services that the user has opted into. These could provide advertising content, localized musical selections, or other musical or spoken word content.

In some embodiments the generate new content form in block 12 has the fundamental difference from the others in that it will apply one or a plurality of artificial intelligence (AI) techniques to generate musical, spoken word, or soundscape content or any permutation thereof, alone or in combination, in real-time within the device based on style specifications combined with numerous weighted parameters selected by the user at the time of programming the action. The parameters used in the generation of content are described with more detail subsequently in this document as well as being described in FIG. 7.

In some embodiments each of the action forms with the exception of the placeholder form can be programmed by the app user to transition from the content previously being played, if any, through multiple types of audio “out” transitions in blocks 13 and 14. Fade down will slowly lower the volume of the content being played until it is no longer audible and pause playback. Sound transitions will allow the user to select a transition sound provided by the app software to play on top of currently playing content and continue playing until an appropriate time after playback has begun for the new content.

In some embodiments upon completion of the audio “out” transition, the software will fetch new content 300 (FIG. 5). This step is valid for Level I and Level II functionality. The decision to select Level I or Level II functionality is made in block 15.

If the Place or Event action involves playing a song, album, artist, playlist, or other forms of existing musical content per block 16, new content will be loaded in block 17 based on app parameters programmed by the user during the initial setup of the Place or Event. The proper content Uniform Resource Locator, or URL, will be identified and referenced by the app software for use by the embedded playback routines presented by the mobile device OS. Playback parameters will then be analyzed in block 18 and set for audio playback to begin. Refer to the app Data Structure Definition subsection below for detailed parameters used.

If the Place or Event action involves playing back episodic content (block 19) such as a podcast, news program, audio book, or related content, the parameters previously set by the user will be evaluated in block 20 to determine which content to play. Refer to the app Data Structure Definition subsection below for detailed parameters referenced here. Once the proper content is determined, the app software will reference the proper asset URL and begin playback in block 21.

In some embodiments the Place or Event action may also involve streaming internet content licensed by business partner streaming services. This is evaluated in block 40. If this content is programmed to be played by the user or flagged for playback by the app software based on third party services opted into by the user, then that selection is registered through the internet with the business partner via third party software as being selected in block 22. Once the proper content is identified, the app software will reference the proper internet URL in block 23 and begin playback. Example use cases of this type of content could include, but not be limited to, live music from a local business that is occurring as the mobile device enters the area, songs selected by a child's school or by a parishioner's church as they approach to reinforce the lessons for them from that day, real estate information for a specific listing being delivered based on the user selecting a Journey that has been provided by a realtor for that area, advertisements streamed by a licensed business partner, or information regarding a landmark or area.

In some embodiments, in block 15, if Level II functionality is requested through user app programming for a Place or Event action, the app software will analyze the associated details and user preferences in block 24 and pass the results to block 25 where AI (Artificial Intelligence) algorithms are applied to determine the proper content selections for playback. The content to be played must be available in the user's third-party licensed library, and will be matched for playback based on publicly available metadata about the Place location or Event parameters or based on the name chosen by the user for the Place or Event. The parameters used by the app software will include, but not be limited to, the song title, album title, music genre, artist, or by matching key words or phrases within the song lyrics with location metadata, for example.

In some embodiments after new content has been fetched and played as described in FIG. 5 or is being generated as described in FIG. 7, blocks 33, 34, and 35 from FIG. 4 will then perform an audio “in” transition, programmed by the user through fading in or overlaying a transition sound. These function identically to the audio “out”functions described previously.

If a new Place or Event has not been encountered to interrupt or replace the content, upon full completion of the current content being played through commands in blocks 21, 23, 25, or 26, the app software will execute the functionality of FIG. 6.

In block 27, the software determines whether the Place or Event action references, plays, or generates episodic content. If so, block 28 is executed to evaluate whether another episode is requested. If additional episodes are requested, user preferences are analyzed in block 29 to determine the next episode to be played: same podcast or program, different podcast or program, play in sequential order, resume where the episode was left in progress, etc. Once the proper content is determined, the app software will reference the proper asset URL and begin playback in block 30.

In block 27, if the app software determines that the Place or Event action does not involve episodic content, block 31 is executed to determine whether “shuffle” or “repeat” functions provided by the operating system (OS) are selected for this action. Once the proper content is determined, the app software will reference the proper asset URL and begin playback in block 32.

In some embodiments the action functionality described above will repeat while the app software is running, either in the foreground on the mobile device, or in the background, until user actions intervene or until another Place or Event trigger is encountered that is programmed to change the mobile device state parameters.

During operation the app software allows for the user to pause or resume sensor group or data source group evaluation via the graphical user interface or via voice commands as implemented by the device OS. Any playback that is already underway will continue while these evaluations are paused, however the app software will cease to perform the evaluations. As such, the app software will not execute any new Place or Event actions. This can be useful to enhance battery longevity or to skip known triggers as desired and allow current content playback to continue uninterrupted, among other use cases.

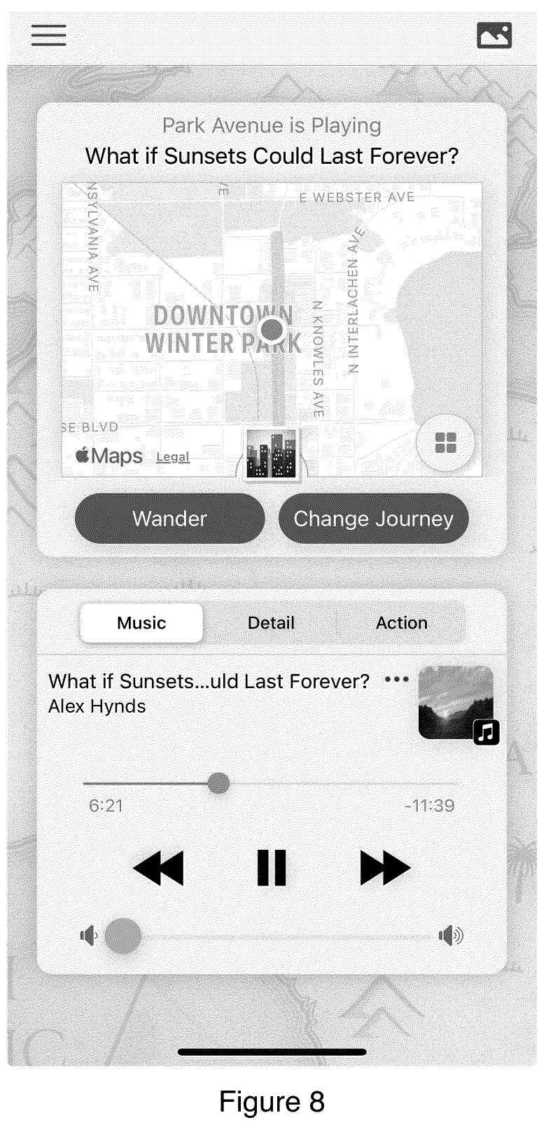

In some embodiments the tool's graphical user interface presents functionality to the user during operation including, but not limited to: a map display, audio transport controls, menu choices for different screen selections, changeable background images both static or moving, information on Journey being executed as well as audio content being played, and Place or Event details (see FIG. 8).

The map display presents the current device location relative to traditional map data as presented by the device operating system (OS), as well as displaying edge outlines for nearby Places as defined within the Journey currently executing or Wander Mode, as appropriate. The map display also allows the user to select a Place for editing.

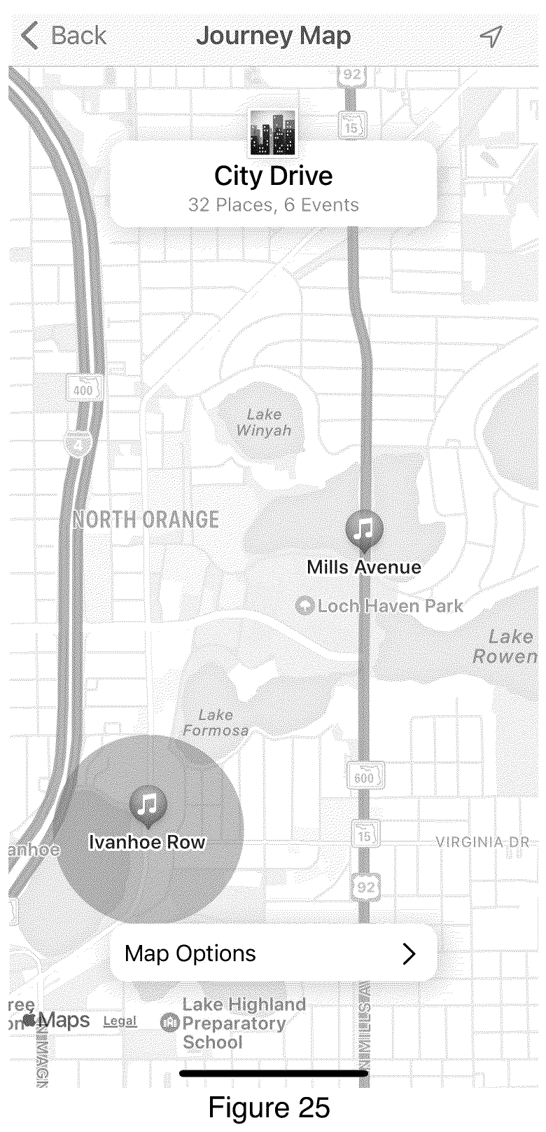

In some embodiments a separate map display (FIG. 25) can be accessed which will show all Places within a Journey and allow the user to navigate around the map to expose additional information for a Place and better understand the relationship between Places in a Journey and what will be encountered throughout its duration.

In some embodiments traditional audio transport controls for play, pause, skip forward, and skip backward are implemented within the graphical user interface. Journey transport controls are also implemented to skip the next defined Place or Event action, to execute the next defined Place or Event action prematurely if desired by the user, or to allow selection of a completely different Journey. The app software also allows for voice input to perform these functions while the tool is operating.

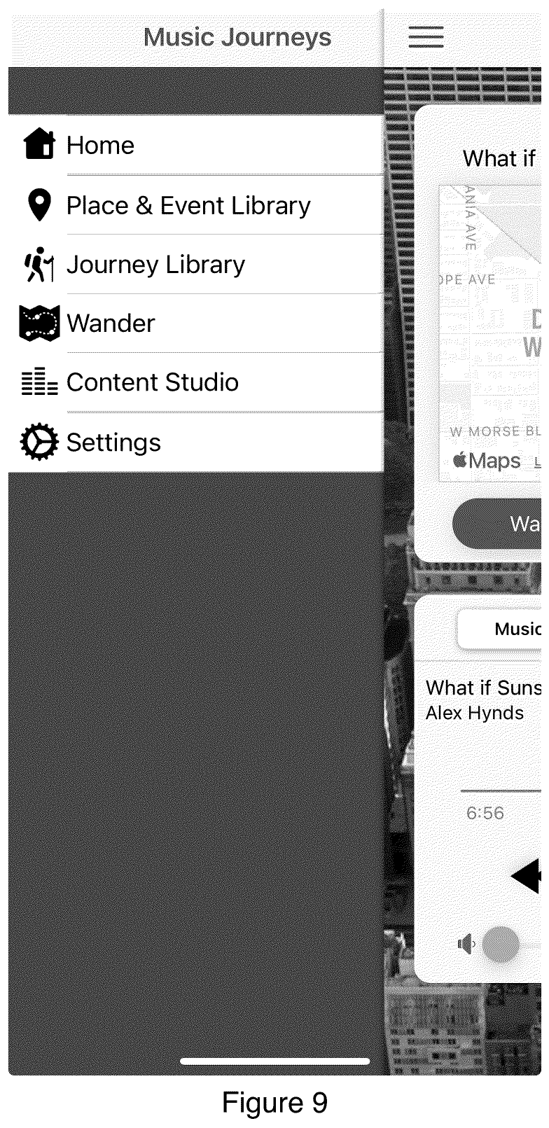

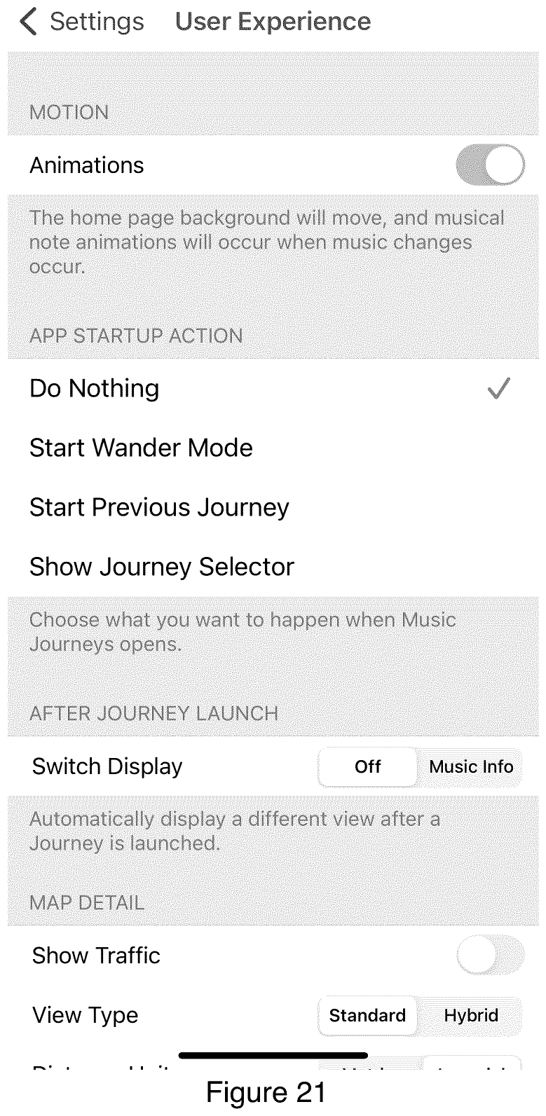

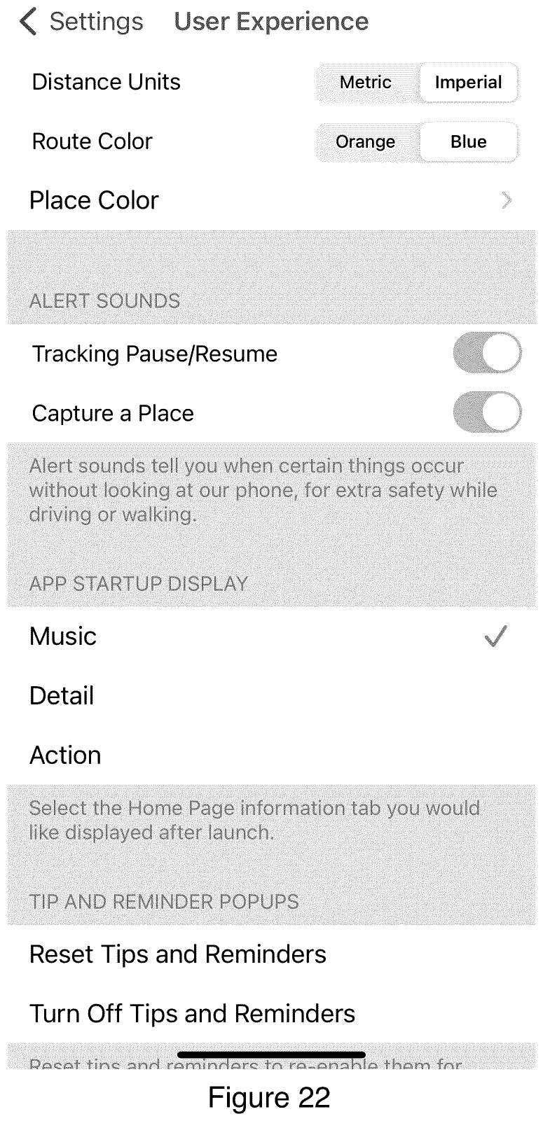

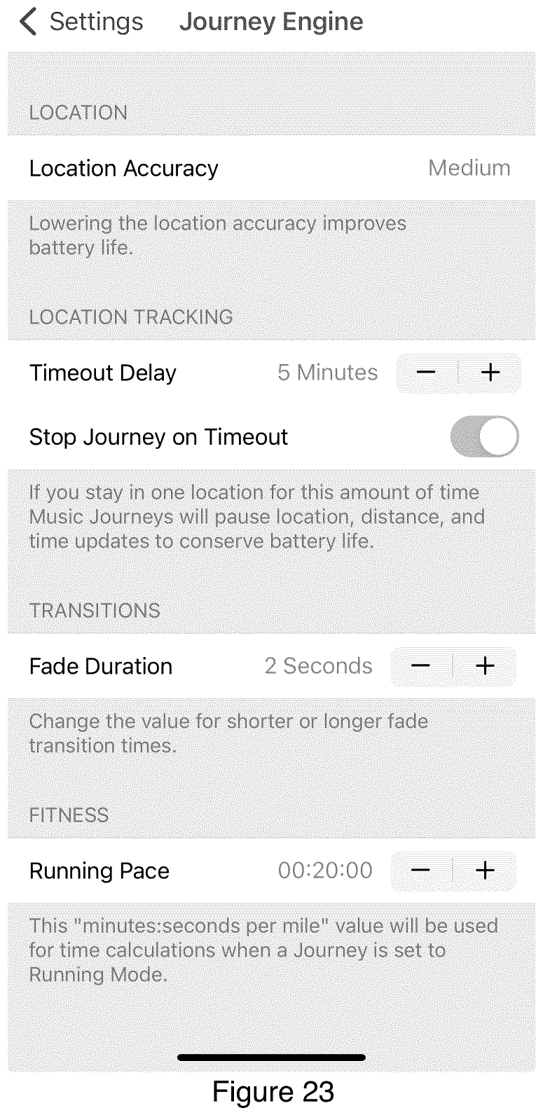

In some embodiments settings are presented through menu choices to allow the user to customize various aspects of the app software user interface such as: background image motion or image selection, map display details, app software sound effects, and default view settings (see FIGS. 9, 21, 22, 23). Additional settings are presented to adjust performance for battery usage and adjust behaviors such as audio fade times.

In some embodiments the app software includes audible indicators of certain user actions in addition to visual and haptic (tactile feedback) confirmation of touch activity, to allow for more complete confirmation when the user is focusing on their travels instead of the device. These are selectable through the app software settings.

In some embodiments during app software operation, location updates and Place actions are allowed to occur both when the app software is functioning in the foreground within the mobile device powering system, as well as in the background, such as when other apps are running, or when the mobile device display is off.

In some embodiments the app software is capable of interfacing with the device operating system (OS) to allow for voice-controlled functionality even prior to its startup or when the app is operating in the background. The functionality available includes, but is not limited to, functionality to launch/pause a Journey or wander mode, pause/resume the use of location updates during operation, or terminate app software execution.

In some embodiments the app software is capable of real-time generation and auditory output of musical content, spoken word narrative content, soundscape content, or any permutation thereof, alone or in combination, referred to as Level III functionality (FIG. 7). This process utilizes style specifications to guide real-time content generation in combination with user-configured proportional parameters and the aggregate status, 36, and applies one or a plurality of artificial intelligence techniques for creating content in real-time generated locally by the mobile device or by an external processing system such as an internet-based server and playing the media content through the mobile device. This internet server is directly related to and wholly a part of this invention. Throughout this document, content generation by the tool is regarded as real-time, defined as output in response to context without a perceptible delay to the user, whether executed locally on the device or on an internet server, and should always be interpreted as real-time even if not explicitly stated.

In some embodiments generation of music compositions, spoken word narrative, soundscape content, or any permutation thereof, or combination thereof, is initiated in block 33 by loading style specifications (hereinafter referred to interchangeably as style specifications, definitions, or styles) in one of two primary ways: either from an internet-based server that is directly related to and wholly a part of this invention, or from a local data store on the mobile device. Style specifications include content generation “rule sets” that have been previously generated through the use of server-side analytics, applying one or a plurality of analysis techniques typically referred to as artificial intelligence to analyze existing musical, narrative, or soundscape content patterns, structures, and techniques. Additionally, style specifications may also include content generation “rule sets” entirely created by a user or based on a template rule set that has been modified by a user. The styles are requested by the app software for a specific Place, Event, or other Journey construct, and provided to the mobile device processor for inclusion in the content generation process.

In block 34, user preferences for content generation are proportionally analyzed to determine certain implementation details, with these particular user preferences being specific to the type of content that is slated to be generated, whether musical compositions, spoken word narratives, soundscapes, or any permutation thereof, alone or in combination. The result of this analysis is combined with the style specification details appropriate to the content type to be generated, to generate an app software content model in block 35A, in preparation for content generation and ultimately for its aural or visual playback.

The mobile device aggregate status is assessed in block 36, combining all data provided by the sensor group and the data source group, along with asynchronous voice input from the user through block 35B. This voice input may provide features such as, but not limited to, suggestions to redirect or change the generated content, queries that can be answered by the generated content, or any other adjustments to the user parameters or style specifications. Any additional parameters that exist for the currently active Place or Event are further evaluated in block 37. These parameters include, but are not limited to, time of day, weather, speed, direction of travel, route type, route method of travel, and additional map location data provided by the host operating system. This parameter evaluation completes the comprehensive understanding of all information necessary to generate content.

Block 38 provides the collection point for the content model as generated in block 34, the aggregate status from block 36, and additional parameters from block 37. Block 38 references the style rule set to act upon all other data that enters the block, subsequently generating the appropriate content in real-time and forwarding it to the output generation hardware and software provided by the media system of the host mobile device, as depicted in block 39.

This analysis and subsequent content generation will take place continuously until a valid Place or Event changes the content or silences its playback.

In some embodiments of the present invention the ability can be provided to allow a form of hybrid musical content generation that includes a combination of melodies, themes, or excerpts of existing musical content and entirely new musical compositions generated and interwoven to create. All existing content to be used in this hybrid fashion must be appropriately licensed to allow for this use in the tool and for authorized use by the specific user. An example of this could be the inclusion of the theme “Dies Irae” in a composition being generated that is associated with the existence of a traffic jam ahead, as the user is traveling, or indicating bad weather approaching. Another example could be interweaving a familiar public domain musical holiday melody with a composition being generated and performed during a late December train ride.

In some embodiments of the present invention the ability can be provided to allow content generation to be paused, faded out, or otherwise altered due to data acquired by the app software from a sensor group. For example, if a user is driving while experiencing generated spoken word narratives from the app software, and the driver needs to make a hard stop or swerve, the app software could assess the situation based on acceleration data, user biometric data, or other sensor data, and alter its content by pausing to allow the driver to fully focus on the safety aspects of the current situation. The spoken word content could then divert to an alternate branch of generation and interactively query the user as to whether the previous content should continue, or whether alternate content be generated or played back. This is not dissimilar to what would happen during a conversation with a human passenger.

In some embodiments of the present invention the app software can be directed to generate content that will span multiple Journeys (hereinafter referred to interchangeably as continuous content or chained content) for a continued experience, which can also include the ability to recall the content generated during any previous Journeys contained within the chain, along with any user interactions therein. An example of this functionality could be a generated spoken word story experience that is programmed to occur for a user's commute Journey during a five-day work week with a story arc that intentionally spans all five days. The narrative story content could be split into five sections, potentially episodic in nature. This functionality would necessarily require the app software to be aware of the intended duration of each of the five segments, along with the actual estimated duration that is predicted by the app software on each day based on route and traffic conditions. In this manner, the app software could fill a specific portion or entire duration of each commute with the content, per user preferences or programming. This chained content functionality could extend to all forms of spoken word narratives or other types of content generation such as musical compositions or soundscapes.

In some embodiments a selection can be made by the user, using GUI controls and displays, to parameterize the content generation and conform it to a specific time range. For example, a user control can be provided that could tailor the content to a specific decade of history while traversing a defined route of travel. As the user travels the route, the music being played back or generated would be tailored to the era selected, and historical details for the locations nearby can be generated and output as spoken word narratives describing historical aspects or specific historical events that took place in the locations. This would provide a custom, themed historical tour in response to a user's interests and desires based on app software settings and input from the appropriate data source group. Verbal interactivity in the form of questions and answers, could subsequently be executed during the travels for learning or deeper dives into the history. Another example could be fictitious or entertainment-based content for a specific era in time, generated in a similar fashion.

In some embodiments the aggregate status of a user and their device can be used to perform actions such as starting, stopping, changing, or otherwise altering the media content being played back or generated in real-time based on current states or developing trends related to a user's level of anxiety or other mental wellness aspects. Trigger criteria for these actions are generated by comparing a measured wellness status and a reported wellness status, to a target wellness status, using measured data from a sensor group in conjunction with specific self-reported information from the user regarding what they enjoy, do not enjoy, like, or dislike, or what is historically known to cause their wellness state to degrade. Sensor data may provide input to the aggregate status regarding user mood, state of mind, level of anxiety, blood pressure, heart rate, or overall emotional state, or other information. Reported status may provide input to the aggregate status regarding a user's personal attributes including, but not limited to, likes, dislikes, anxieties, irritants, triggers, gratitude's, desires, worries, pleasures, comforts. Reported status may be manually entered by the user directly within the tool on the mobile device or from an internet-based server that is directly related to and wholly a part of this invention, or acquired by a conversational natural language interface between the tool and the user. For example, a user may provide information to the tool by using a natural language interface stating that their anxiety level increase rapidly when they approach a bridge while driving, or when they see stopped traffic ahead during rush hour. The app software could be configured by the user to either automatically play back or generate specific calming content, or to display a simple user control at that moment to allow the user to decide between changing the content to lower their anxiety or continuing with the current content.

In some embodiments, additional functionality within the graphical user interface includes, for example, the ability to customize the user interface including preprogrammed as well as user uploaded screen backgrounds that may have motion behind the primary user interface; ability for user to alter the display aspects of the navigational user interface; interact with voice control for Journey triggering or Wander Mode while the app tool is not currently running; display all pertinent details of the content being played including, as appropriate, artist, composer, album, playlist, play time, album art, podcast, episode, new program, radio channel, etc.; provide the ability for a moving background image behind the home page displays and controls, including artwork provided by the app tool as well as the ability for the user to upload their own background image of preference; popup information on musical content being played including, as appropriate, artist, composer, album, playlist, play time, album art, podcast episode, news program, radio channel, etc.; ability for the user to like/dislike content and have those preferences transmitted to the content providing service that is serving the content.

Utilizing the graphical user interface presented by the app software through the device operating system, the user must first create Places or Events and their corresponding actions per their preference. The user can assign Places and their associated actions to Wander Mode or compile Places or Events and their corresponding actions into one or more Journeys. This section describes processes and details associated with defining the parameters of each of these data structures stored by the app software.

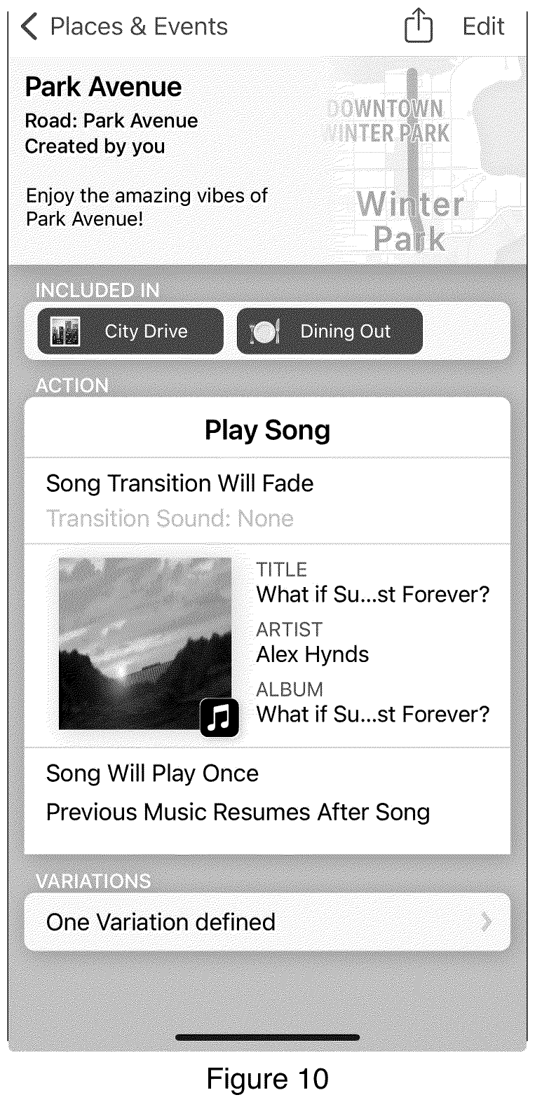

Place parameters are defined by the user or by a third-party external data source service opted into by the user, functioning as the basis for all other activity in Levels I, II, and III. A primary method of defining a Place can be done manually regardless of current mobile device location. The user selects a unique name for each Place, followed by the selection of the Place detail parameters shape (any shape desired), edge parameters, and size (any size) of the Place including: circular, elliptical, rectangular, user-defined polygonal shape, or a specific route of travel such as a roadway, sidewalk, railway, subway, watercraft path, or trail (see FIGS. 10, 11, 12).

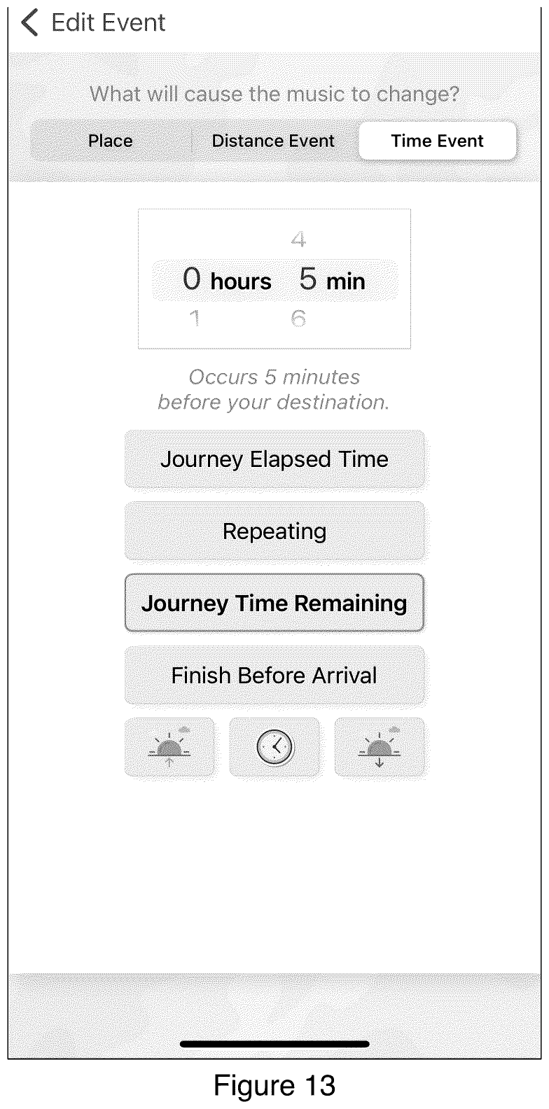

Event parameters are defined by the user or by a third-party external data source service opted into by the user, functioning as the basis for all other activity in Levels I, II, and III. A primary method of defining an Event can be done manually regardless of current mobile device sensor group data. The user selects a unique name for each Event, followed by the selection of the pertinent and desired detail parameters regarding sensor group parameters or data source group criteria for this specific Event (see FIG. 13).

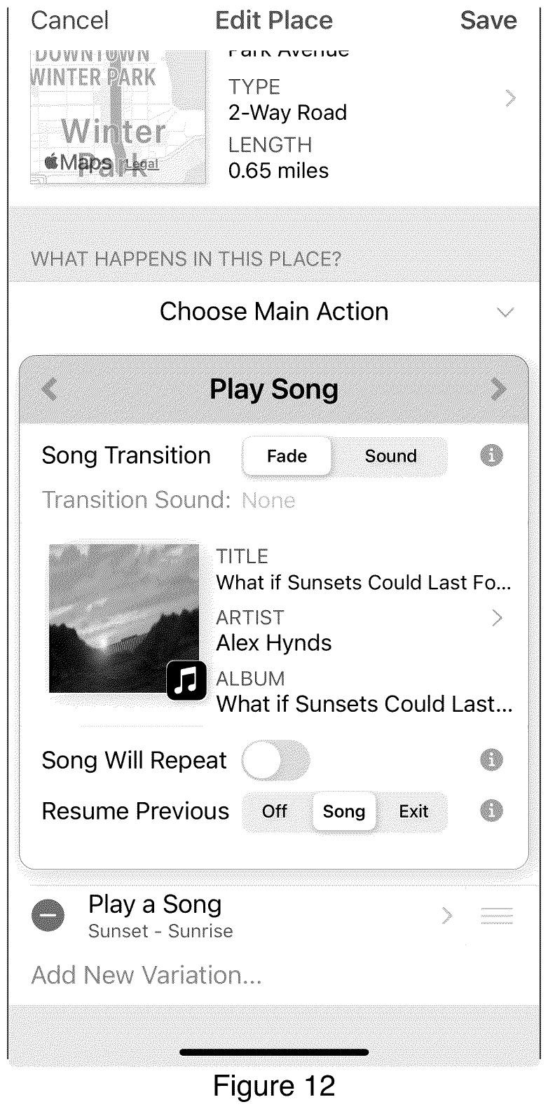

In addition to Place or Event naming and detail parameter configuration, the app tool software allows the user to select which action is to be executed upon encountering the Place or Event, as described above. After selection of the action, the tool presents an appropriate set of default parameters for the chosen action to the user for adjustment. These parameters can be described in three separate categories: timing parameters, transition parameters, and content parameters (see FIG. 12).

In some embodiments selection of timing parameters allow the Place or Event action to occur either immediately upon encountering the trigger condition or defer the action until full completion the content currently being played. Adjustment of an additional timing parameter will allow for the new content to be started at a specific time offset within its data. An example use would be to begin playback of a song not at its beginning, but one minute and two seconds into its duration at a favorite musical or spoken word passage.

In some embodiments transition parameters enable various methods of audio volume changes, timing, and sound effects to be coupled with the change in content. The transition types include volume fade down, volume fade up, volume crossfade (overlapping content where the volume of the original content fades down simultaneously with the volume for the replacement content fading up), or volume duck (volume for the original content decreases a predefined amount, new content is played over the original content, and upon completion of the new content the volume for the original content increases to its original state). All audio fade durations and volume levels are selectable through the graphical user interface. An additional type of transition is the ability to select an audio countdown to overlap the primary content prior to entering a Place, based on user selectable parameters. One example of this would be a verbal countdown for joggers/runners, prior to encountering a Place or Event, that serves as a preprogrammed milestone on their route. Another example would allow content streamed by a localized business entity to be temporarily overlaid on the ducked (an audio production term meaning lowered volume) content related to a Place or Event that has recently been entered.

In some embodiments sound effects for use in transitions are primarily sourced directly from the compiled app software, however the app software also provides the ability for the user to record, produce, and save their own sound effects for use in this capacity.

Content parameters selectable for non-episodic musical content can include, but not be limited to, song, album, artist, genre, or playlist, as well as selectable playback details such as repeat song, repeat all, shuffle, and play a single random song from a playlist. Content parameters can also include playback of streaming content from a third-party service, such as radio channels or other content channels, for example.

For episodic content, whether existing content or new content being generated by the tool, the parameters presented include next episode in a podcast or program, random episode, continue previously played episode, continue with next episode vs. stop after a single episode, play episode from podcast A, then move to next episode from podcast B, etc.

All parameters as described above are saved in the app's software accompanying data structure to be recalled and executed by the app software when appropriate, based on location and other conditions.

In some embodiments an alternate method for defining a Place is to enter Journey Capture Mode and begin traveling on a planned route. During motion, the app software allows for the user to touch a large area of the device screen or a wirelessly connected wearable device to capture that location in latitude and longitude. This location is loaded into a new Place and assigned a generic name, allowing the user to edit each of the new defined Places and add the remaining details such as Place action after Capture Mode is exited. This alternate method allows for the creation of multiple Places in one session.

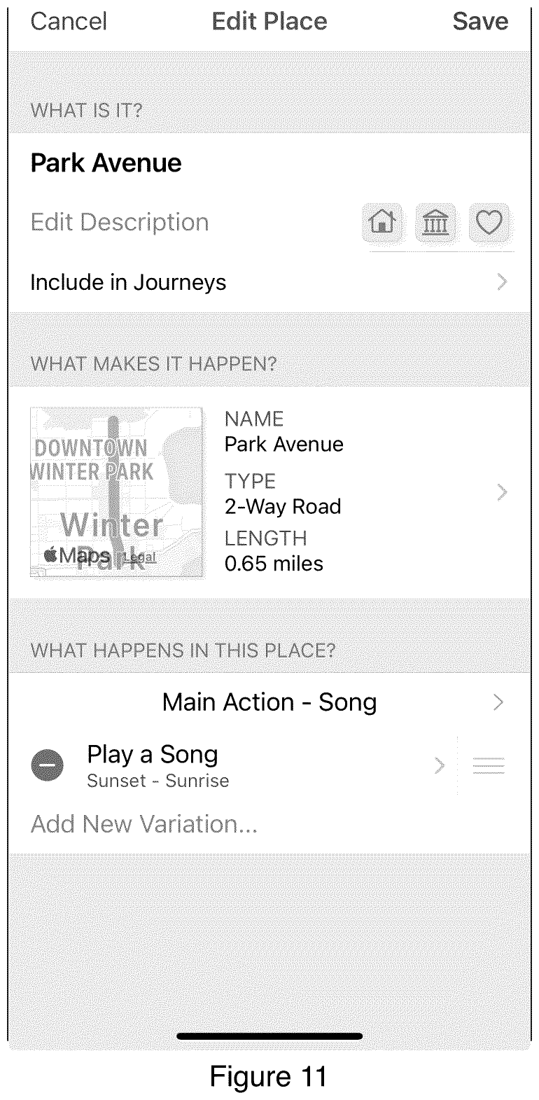

In some embodiments a second alternate method for defining a Place called Map Mode, is similar to Capture Mode, but does not require the user and mobile device to be traveling. The user enters this mode and manually manipulates a map interface to the desired location and captures a new Place in latitude and longitude. Similarly, this allows the user to define multiple Places during one session and return afterward to complete the Place details (see FIGS. 11, 12).

In some embodiments one or more variations on a Place or Event default action can be created and saved by the user. These variations are alternate actions that replace the default action when certain parameters are met. Multiple variations can be created by the user through the graphical user interface and prioritized to take precedent over one another in the event that conditions are met for multiple variations at once. This ensures that only a single action will happen when encountering a Place or Event, whether default or one of the defined variations.

In some embodiments variations are created by selecting and configuring parameters that include, but are not limited to, time of day range, sunrise/sunset, day of the week, round trip status, which Journey is being executed, weather parameters, distance from the center point of a Place, and direction of entry into a Place. These conditions can be stacked or combined to create a single variation. An example stacked variation would be a configuration to play a victory song when the user is on their Monday morning exercise run and returns to their point of origin. The conditions selected for this variation could be, for example, Monday between sunrise and 9:00 AM when the user returns to the starting location during a round trip.

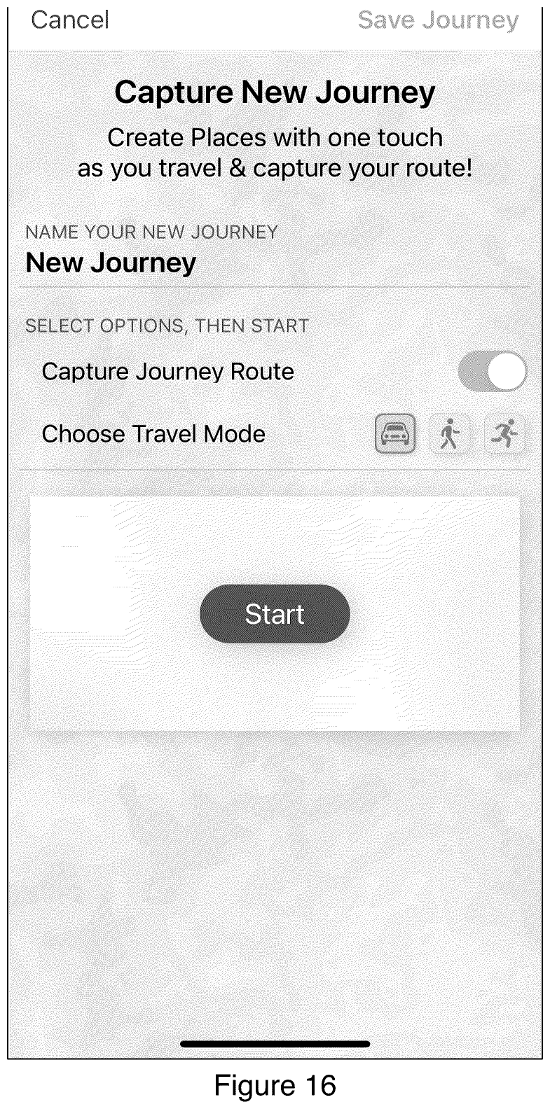

In some embodiments Journeys are collections of previously defined Places or Events that are also stored by the app software in the core data structure. They can be manually compiled through the graphical user interface directly within the tool on the mobile device or from an internet-based server that is directly related to and wholly a part of this invention, downloaded manually by the user or automatically from the internet, or built during transit by using Capture Mode (see FIG. 16) or Map Mode.

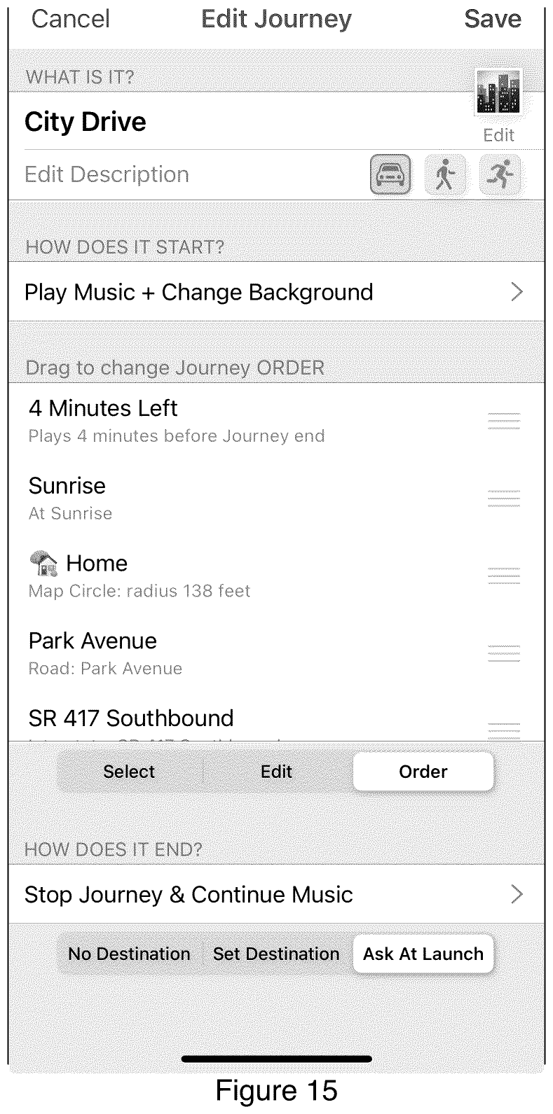

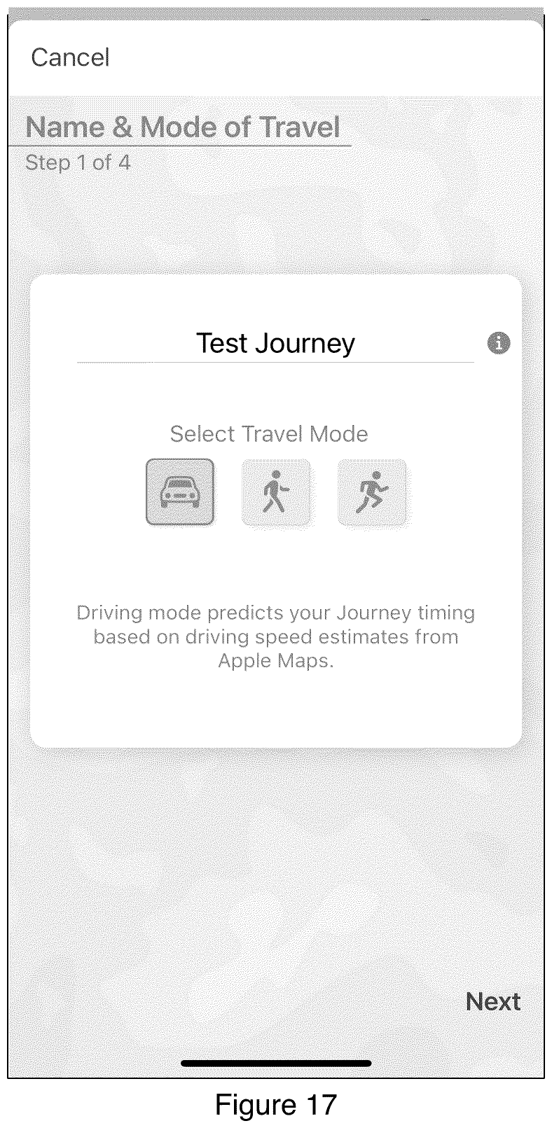

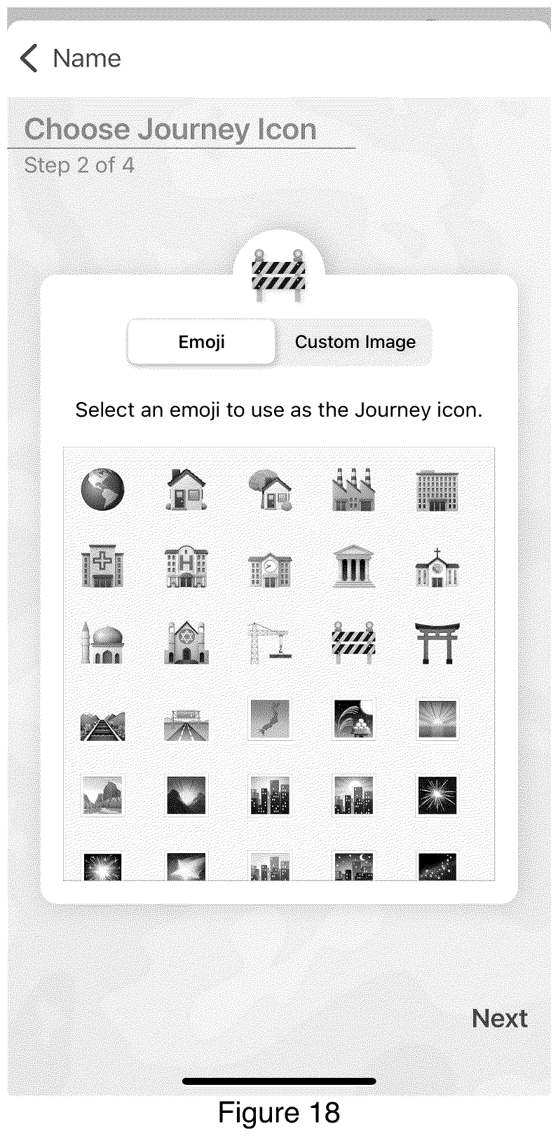

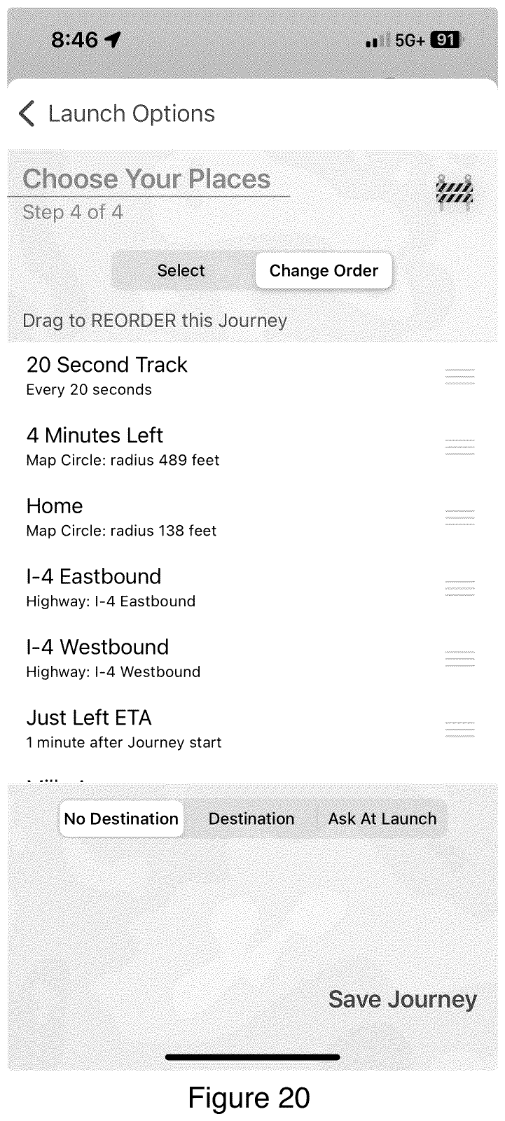

In the manual Journey definition process, the user would assign a name to the Journey, select an icon to represent it on the main screen of the app software, and would select which Places or Events to include in that Journey. If the Journey is to be travelled in the same sequence each time it is executed, the Places or Events can be configured by the user or automatically predicted by the tool in the order they are expected to be encountered. This ordering process then allows the app software tool to provide enhanced functionality such as predicting the time to the next Place or Event at the current rate of travel, allowing for an audible verbal countdown or musical fanfare tracks to be overlaid on the primary content, etc. The ordering process also unlocks additional functionality that allows the user to simulate a Journey in advance of traveling by manually stepping through the included Places or Events in proper order, and experiencing the Journey as it will occur when traveling, including programmed content playback, volume levels, and all aspects of content transitions previously defined (see FIGS. 15, 17, 18, 19, 20).

In some embodiments Capture Mode, as previously referenced in this disclosure, not only serves as an alternate method of defining multiple Places, but it also actually defines and saves a new Journey that includes those Places in the expected order of their encounter.

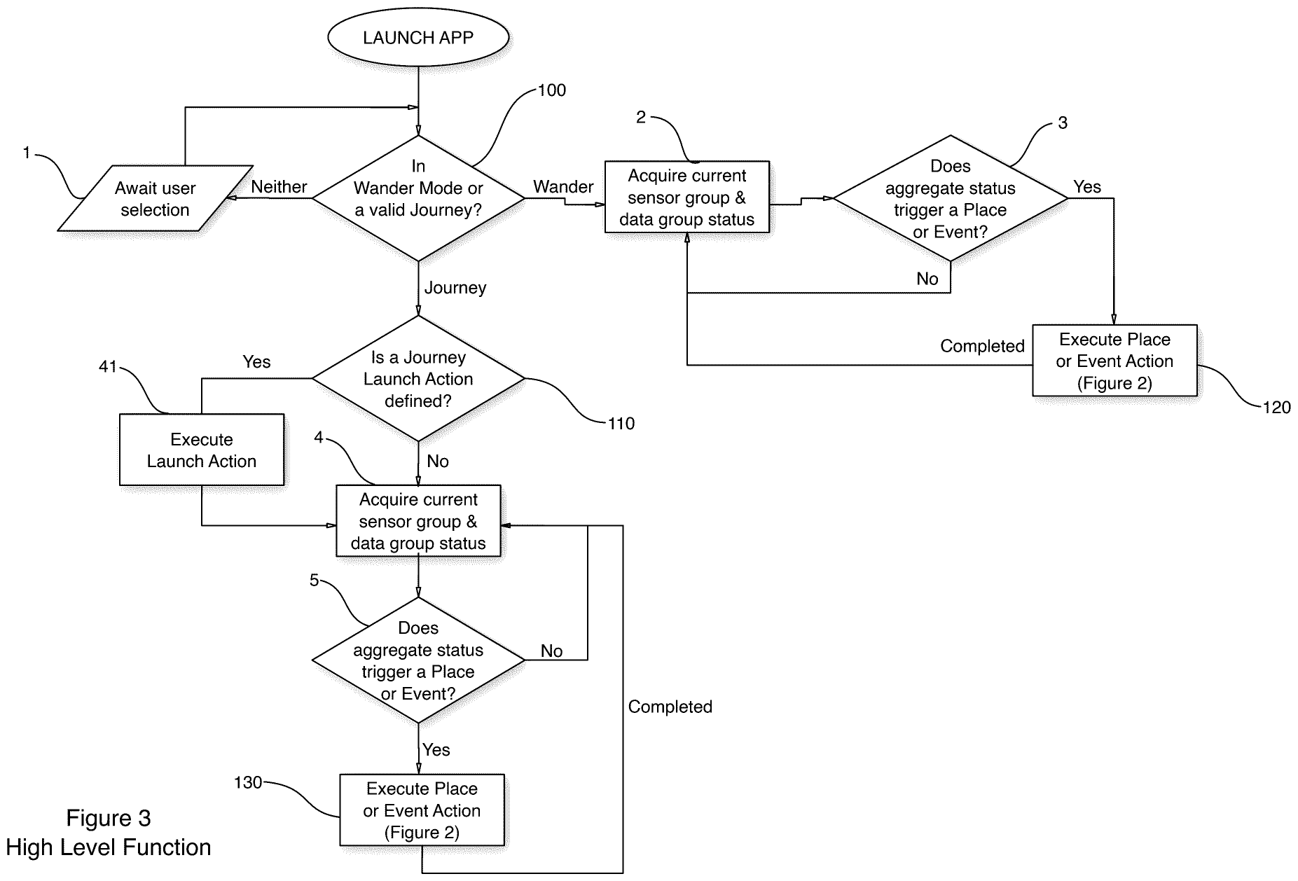

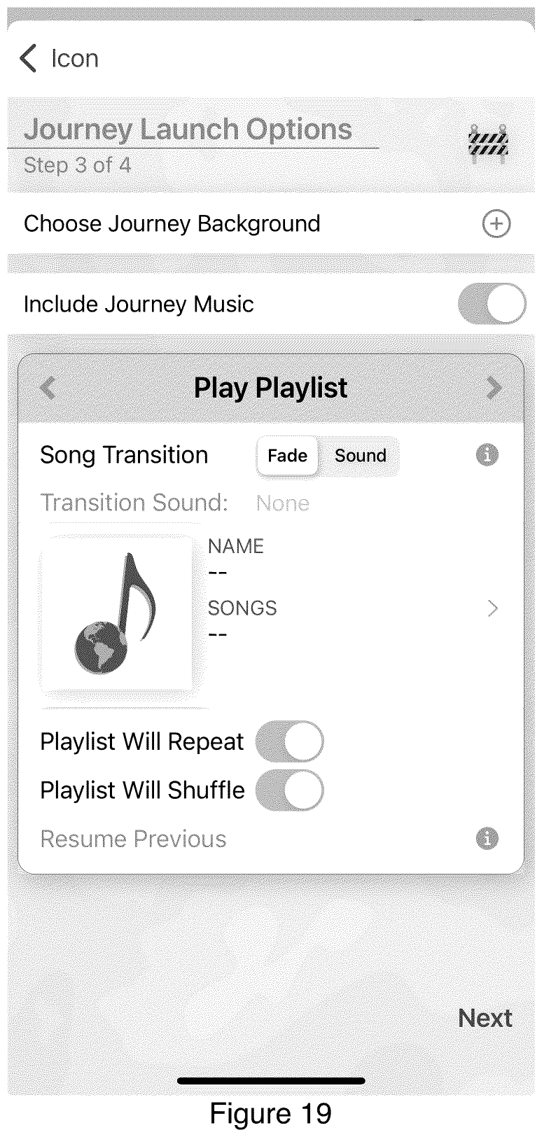

Regardless of the method used to create a Journey, the app software also presents a method to select a launch action that can be added to perform any of the previously described Place or Event actions upon execution of the Journey (see FIG. 3, block 41). This allows for media content to be played when Journey is selected, even if the user mobile device has not encountered a Place or Event in the Journey yet. Similarly, the app software also presents a method to select a base action that can be added to a Journey, to allow for a standard set of content to be played after completion of any content that was triggered by an action. These two functions allow for content to be played at all times during Journey if desired by the user, whether or not an action is active and in effect at the time (see FIG. 19).

In some embodiments the app software has a mechanism included to export and import Places, Events, Journeys, or custom media content. This allows for sharing of individual data structures between users, while also allowing for data structures imported from or exported to a collective marketplace or imported automatically based on location from a third-party service opted into by the user. Shared Places, Events, Journeys, custom media content, or musical content style specifications can be imported and exported as files. This enables sharing via email or through close range wireless transfer between like applications, as supported through the host operating systems (OS).

In some embodiments the app software allows licensed wireless content streaming capabilities from business partner content services via the internet into the user mobile device. This could be used, for example, to extend the media experience of the third-party business outside its physical boundaries when a user defines that region as a Place and enters the Place. Through the embodiments previously described, the third-party business could share their predefined Place, including their content URL, with the user via email or other means in advance of the user arrival. Examples for this functionality may include, but are not limited to, a restaurant, tourist attraction, public park, or nightclub. Automated downloading/streaming and location-based playback of advertising or promotional content or localized music content can also be accommodated through this embodiment of the app software. Example use cases may include audio tours for tourist attractions, educational tours, or historic tours including spoken word and/or other streamed content, and/or musical content previously licensed by the user through a third-party music service.

In some embodiments the app software contains provisions through an application programming interface (API) to enable music, navigation, or other types of third-party mobile device applications to license the full location-based content functionality provided by this invention, including the display of portions of the subject app's standard user interface within the third-party application.

In some embodiments the app software provides the ability for a user to record, edit, and save their own audio content to be programmed for playback based on location and other parameters as previously defined within this document. This functionality allows for customized vocal, musical, or sound effect content to be utilized within a Journey, in any combination with prerecorded and licensed content as well as original content generation.

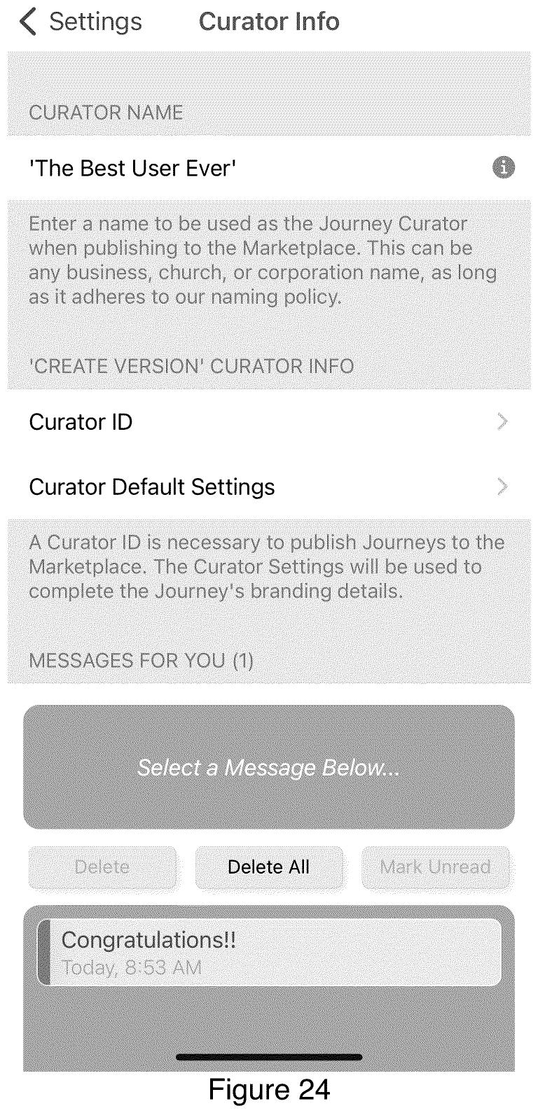

In some embodiments the app software provides the ability through a business partnership with, for example, a performing arts center or other performance venue, to remotely update and publish a Journey to be used by their patrons prior to, during, or after an event that would play musical, spoken word, or soundscape content, or any permutation thereof, alone or in combination, related to the event at hand including, but not limited to, arrival music, announcements, advertising, or reminders. Another example of this type of functionality could include a business partnership with third-party event or movie theater ticketing agencies or apps to automatically link a Journey of their creation to a user's device that would provide relevant content from a third-party music service, from a custom recorded audio track created by business representative, or from custom-generated media content as a user travels to or from the event. The business user or individual user that creates, publishes, and sustains the programming of such a Journey is referred to herein as a Journey Curator (see FIG. 24).

In some embodiments the app software provides a mechanism to host user-created or third party-created functions for target groups of runners, walkers, and the like, to guide them using Places and Events containing spoken word, sound effect, or musical cues as they arrive at a location, and through these cues have them head to a new location where a subsequent Place will trigger and provide the next level of guidance, and so on. This would provide a form of guided mobile entertainment experience through the mobile device. The individual user that creates, publishes, and sustains the programming of a Journey for such a function is referred to herein as a Journey Curator (see FIG. 24).

In some embodiments a GUI can be provided through a local application or an internet browser on a device other than the mobile device, such as a desktop, to enable the user or the Journey Curator to program the content for one or a plurality of Journeys to be executed at a later point by that user or by other users of the tool. Through this mechanism, implemented as a drag and drop interface or equally flexible and accessible method, an entire slate of programming can be predetermined for a Journey and experienced later as the mobile device and its user travels and encounters Places and Events. For example, a user could preselect content to be played back or generated by the tool for an upcoming road trip with their family, with selections such as generated narrative content at certain locations or related to specific visible landmarks along a route, interleaved with specific types of musical selections, as well as time or distance spoken word announcements. This example could also include tactics to break up the monotony of such a family road trip by changing from spoken word content to musical content at specific percentages of the trip's total distance, or by interjecting an appropriate spoken word joke, learning opportunity, religious scripture passage, or anecdote during the musical selections to retain interest. Additionally in this example, specific musical or spoken word content could be selected for playback or generation at a specific time to, or distance away from, their ultimate destination. When the family road trip begins, a user would instruct the tool to begin executing the Journey that was previously created to provide the desired experience for the duration of their road trip.

In some embodiments the app software can be capable of combining the user location and Place data from internet servers to identify suggested additional Place locations for downloading to the mobile device, or to otherwise enable them for the user. Examples of this include, but are not limited to, alerting the user to shared Places that may be of interest to them, previously uploaded by other users or business partners. The user could opt to import these Places or the larger shared Journey of which they may be a part.

We claim:

1. A computer-implemented method of providing media content through a mobile device, comprising:
determining a location condition comprising:
receiving a definition of a route of travel, the definition comprising a name definition, a geographical definition, and a motion definition;
determining that the mobile device is within a threshold distance from the route of travel and is traveling in accordance with the current route of travel and the projected route of travel trajectory;
receiving a definition of motion, the definition comprising data from one or a plurality of sensors representing speed, acceleration, and bearing;
determining that the mobile device is traveling within a threshold range of the motion definition;
receiving a definition of a journey, the definition comprising a collection of routes;
determining whether a variation condition is met and executing an action in case the variation condition is met, wherein the executing comprises triggering an alternate action that takes priority over a default action in case one or a plurality of variation conditions other than the location condition are met;
selecting media content as a function of the variation condition, wherein the variation condition includes identifying parameters related to a journey;
selecting media content from available media content that is available to the mobile device based on the determining that the mobile device is within the threshold distance from the route of travel and is traveling within the threshold range of motion of the route of travel and determining that the variation condition is met, the selected media content being associated with the name definition or the geographical definition or the motion definition;
queuing the selected media content for playback on the mobile device in a media queue, the media queue comprising a travel parameter; and
presenting media content from the media queue through the mobile device based on the travel parameter.

2. The computer-implemented method of claim 1, wherein the name definition is based on user data or media data, and wherein the geographical definition comprises:
a geographical boundary surrounding a geographic position defined by a user and associated with the measured route of travel as indicated by sensor data; and
a geographical boundary surrounding a geographic position defined by a user and associated with the expected route of travel.

3. The computer-implemented method of claim 1, wherein determining that the mobile device is within the threshold distance comprises receiving geolocation data for the mobile device.

4. The computer-implemented method of claim 3, wherein the geolocation data is Global Positioning System (GPS) data, wireless base station connectivity data, cellular base station connectivity data, proximate wireless beacon connectivity data, or environmental mapping data using LIDAR or camera sensor input.

5. The computer-implemented method of claim 1, wherein determining that the mobile device is within the threshold range comprises receiving motion data for the mobile device.

6. The computer-implemented method of claim 5, wherein the motion data comprises speed, acceleration, or bearing data.

7. The computer-implemented method of claim 1, wherein selecting the media content comprises:
identifying a playback action associated with the name definition, the geographic definition, or the motion definition, or any combination thereof;
searching available media content based on the playback action; and selecting the media content based on the playback action.

8. The computer-implemented method of claim 7, wherein the playback action comprises at least one of playback of a single piece of media content, playback of a sequence of pieces of media content, and playback of at least a portion of an external stream of media content.

9. The computer-implemented method of claim 1, wherein available media content that is available to the mobile device comprises media content stored on the mobile device, external streams of media content accessible to the mobile device, and artificially generated compositions of media content generated locally by the mobile device or by an external processing system such as an internet-based server.

10. The computer-implemented method of claim 1, further comprising:
receiving a plurality of definitions of a plurality of routes of travel;
determining that the mobile device is within the threshold distance from at least one route of the plurality of routes;
determining that the mobile device is within the threshold range from at least one motion range of the plurality of motion ranges;
selecting media content from available media content that is available to the mobile device based on the determining; and
queuing the selected media content for playback on the mobile device in the media queue.

11. The computer-implemented method of claim 1, wherein available media content that is available to the mobile device comprises artificially generated compositions of musical media content generated by the processing device further comprising:
receiving a plurality of definitions of a plurality of routes of travel;
determining that the mobile device is within the threshold distance from at least one route of the plurality of routes;
determining that the mobile device is within the threshold range from at least one motion range of the plurality of motion ranges;
receiving one or a plurality of definitions of musical style, the definition comprising music genre, composer, artist, performer, instrumentation, orchestration, tempo, dynamics, melodic complexity, harmonic language, rhythmic character, texture, expressive elements, or melodic and harmonic tropes;
generating the musical media content by applying one or a plurality of artificial intelligence techniques as a function of parameters selected from a parameter group consisting of a musical style specification, a route definition, and current sensor data provided by sensors embedded in the mobile device or by sensors connected wirelessly or through cabling to the mobile device;
generating media content from the mobile device to represent the musical composition, or any permutation thereof, either alone or in combination with the computer-implemented method of claim 12 and the computer-implemented method of claim 13, wherein the media content comprises synthesized audio waveforms.

12. The computer-implemented method of claim 1, wherein available media content that is available to the mobile device comprises artificially generated spoken words of narrative content generated by the processing device further comprising:
receiving a plurality of definitions of a plurality of routes of travel;
determining that the mobile device is within the threshold distance from at least one route of the plurality of routes;
determining that the mobile device is within the threshold range from at least one motion range of the plurality of motion ranges;
receiving one or a plurality of definitions of narrative style, the definition comprising fiction, nonfiction, age rating, language, narrative perspective, sentence structure, vocabulary and diction, tone and mood, setting and imagery, descriptive detail, dialogue style, characterization techniques, plot structure, themes and motifs, narrative voice, symbolism and allegory, irony and satire, rhetorical devices, narrative devices, structural innovations, voice playback parameters, weather conditions, user preferences, and narrative purpose further comprising: general storytelling, interactive conversation, education, information, inspiration, historical, or calming;
generating the narrative content by applying one or a plurality of artificial intelligence techniques as a function of parameters selected from a parameter group consisting of a narrative style specification, a narrative purpose definition, a route definition, and current sensor data from the mobile device or from devices connected wirelessly or through cabling to the mobile device;
generating media content from the mobile device to represent the narrative spoken word composition, or any permutation thereof, either alone or in combination with the computer-implemented method of claim 11, representing generated musical content, and the computer-implemented method of claim 13, wherein the media content comprises synthesized audio waveforms.

13. The computer-implemented method of claim 1, wherein available media content that is available to the mobile device comprises artificially generated soundscape content generated by the processing device further comprising:
receiving a plurality of definitions of a plurality of routes of travel;
determining that the mobile device is within the threshold distance from at least one route of the plurality of routes;
determining that the mobile device is within the threshold range from at least one motion range of the plurality of motion ranges;
receiving one or a plurality of definitions of soundscape style, the definition comprising sound source selection, integration of actual sounds that exist in the environment surrounding the mobile device, reactive content based on items that exist in or visual views of the environment surrounding the mobile device, spatialization, dynamic range, frequency spectrum, density and texture, temporal structure, morphology, sonic signature, emotional and storytelling criteria, processing and modulation, cultural and symbolic referenced, spatialization techniques;
generating the soundscape content by applying one or a plurality of artificial intelligence techniques as a function of parameters selected from a parameter group consisting of a soundscape style specification, a route definition, and current sensor data provided by sensors embedded in the mobile device or by sensors connected wirelessly or through cabling to the mobile device;
generating media content from the mobile device to represent the soundscape composition, or any permutation thereof, either alone or in combination with the computer-implemented method of claim 11, representing generated musical content, and the computer-implemented method of claim 12, representing generated narrative spoken word content, wherein the media content comprises synthesized audio waveforms.

14. The computer implemented method of claim 1, wherein the variation condition includes a route type parameter, the parameter comprising number of lanes, expected speed of travel, or road hierarchy.

15. The computer implemented method of claim 1, wherein the variation condition includes a route method of travel parameter, the parameter comprising the expected method of travel for the route, examples of which include, but are not limited to, car, bus, aircraft, boat, train, running, walking, or traveling by wheelchair.

16. The computer-implemented method of claim 1, wherein the variation condition includes one or a plurality of the following parameters: a weather parameter, a round-trip status parameter, a day of the week parameter, or a time-of-day parameter.

17. The computer implemented method of claim 1, wherein the variation condition further comprising a parameter selected from the group consisting of a weather condition parameter, a route type parameter, a route method of travel parameter, a round-trip status parameter, a day of the week parameter, and a time-of-day parameter.

18. The computer-implemented method of claim 11, the computer-implemented method of claim 12, and the computer-implemented method of claim 13, wherein any newly generated content can be captured and saved during an initial experience by a first user, then subsequently shared with one or a plurality of additional users and recreated on their associated mobile devices while traveling an identical route, to duplicate the initial experience of the first user.

19. A computer-implemented method of providing media content through a mobile device, comprising:
determining a distance condition comprising:
receiving a definition of a distance event, the definition comprising a name definition and a geographical definition;
determining that the mobile device is greater than, equal to, or less than a threshold distance from a reference location;
receiving a definition of a journey, the definition comprising a collection of distance events;
determining a destination definition comprising:
receiving a definition of a journey destination, the definition comprising a name definition, a geographical definition, and a destination payload definition;
determining that the mobile device is greater than, equal to, or less than a threshold distance from the geographical definition;
determining that the destination has a payload comprising:
one or a plurality of payload items such as, but not limited to: specific media content; a spoken word announcement; a URL or other information packet provided by a destination business or individual for announcing, playing back specific media content, or displaying within the tool; or contact information for a resident of the destination for communicating, further comprising: a phone number or email for sending a pre-arrival text message; or an instance of the tool installed on their phone which may provide messaging or other corresponding local media content actions;
selecting media content or performing communication activities as a function of the destination condition and its payload;
determining whether a variation condition is met and executing an action in case the variation condition is met, wherein the executing comprises triggering an alternate action that takes priority over a default action in case one or a plurality of variation conditions other than the distance condition are met;
selecting media content as a function of the variation condition, wherein the variation condition includes identifying parameters related to a journey;
selecting media content from available media content that is available to the processing device based on the determining that the processing device is greater than, equal to, or less than the threshold distance and determining that the variation condition is met, the selected media content being associated with the name definition or the geographical definition;
queuing the selected media content for playback on the mobile device in a media queue, the media queue comprising a travel parameter; and
presenting media content from the media queue through the mobile device based on the travel parameter.

20. The computer-implemented method of claim 19, wherein the name definition is based on user data or media data, and wherein the distance event definition comprises:
a geographical location definition, the definition comprising one or a plurality of parameters, the parameters further comprising: latitude, longitude, altitude, or indoor location parameters within a building or facility defined with respect to physical attributes of the indoor location;
a reference definition, the definition comprising distance relationships of a journey, the relationships further comprising: distance traveled since beginning travel, repeating distance of travel during the journey, distance to an expected waypoint during the journey, percentage progress between the beginning of travel and the destination, and distance to the expected destination.

21. The computer-implemented method of claim 19, wherein determining that the mobile device is within the threshold distance comprises receiving geolocation data for the mobile device.

22. The computer-implemented method of claim 21, wherein the geolocation data is Global Positioning System (GPS) data, wireless base station connectivity data, cellular base station connectivity data, proximate wireless beacon connectivity data, or environmental mapping data using LIDAR or camera sensor input.

23. The computer-implemented method of claim 19, wherein determining that the mobile device is within the threshold distance comprises receiving location data for the mobile device.

24. The computer-implemented method of claim 19, wherein selecting the media content comprises:
identifying a playback action associated with the name definition and the geographic definition;
searching available media content based on the playback action; and selecting the media content based on the playback action.

25. The computer-implemented method of claim 24, wherein the playback action comprises at least one of playback of a single piece of media content, playback of a sequence of pieces of media content, and playback of at least a portion of an external stream of media content.

26. The computer-implemented method of claim 19, wherein available media content that is available to the mobile device comprises media content stored on the mobile device, external streams of media content accessible to the mobile device, and artificially generated compositions of media content generated locally by the mobile device or by an external processing system such as an internet-based server.

27. The computer-implemented method of claim 19, further comprising:
receiving a plurality of definitions of a plurality of distances;
determining that the mobile device is within a threshold distance from at least one reference location of the plurality of reference locations;
selecting media content from available media content that is available to the mobile device based on the determining; and
queuing the selected media content for playback on the mobile device in the media queue.

28. The computer-implemented method of claim 19, wherein available media content that is available to the mobile device comprises artificially generated compositions of musical media content generated by the processing device further comprising:
receiving a plurality of definitions of a plurality of distances;
determining that the mobile device is within the threshold distance from at least one reference location of the plurality of reference locations;
receiving one or a plurality of definitions of musical style, the definition comprising music genre, composer, artist, performer, instrumentation, orchestration, tempo, dynamics, melodic complexity, harmonic language, rhythmic character, texture, expressive elements, or melodic and harmonic tropes;
generating the musical media content by applying one or a plurality of artificial intelligence techniques as a function of parameters selected from a parameter group consisting of a musical style specification, a route definition, and current sensor data provided by sensors embedded in the mobile device or by sensors connected wirelessly or through cabling to the mobile device;
generating media content from the mobile device to represent the musical composition, or any permutation thereof, either alone or in combination with the computer-implemented method of claim 29 and the computer-implemented method of claim 30, wherein the media content comprises synthesized audio waveforms.

29. The computer-implemented method of claim 19, wherein available media content that is available to the mobile device comprises artificially generated spoken words of narrative content generated by the processing device further comprising:
receiving a plurality of definitions of a plurality of distances;
determining that the mobile device is within the threshold distance from at least one reference location of the reference locations;
determining that the mobile device is within the threshold range from at least one motion range of the plurality of motion ranges;
receiving one or a plurality of definitions of narrative style, the definition comprising fiction, nonfiction, age rating, language, narrative perspective, sentence structure, vocabulary and diction, tone and mood, setting and imagery, descriptive detail, dialogue style, characterization techniques, plot structure, themes and motifs, narrative voice, symbolism and allegory, irony and satire, rhetorical devices, narrative devices, structural innovations, voice playback parameters, weather conditions, user preferences, and narrative purpose further comprising: general storytelling, interactive conversation, education, information, inspiration, historical, or calming;
generating the narrative content by applying one or a plurality of artificial intelligence techniques as a function of parameters selected from a parameter group consisting of a narrative style specification, a narrative purpose definition, a route definition, and current sensor data from the mobile device or from devices connected wirelessly or through cabling to the mobile device;
generating media content from the mobile device to represent the narrative spoken word composition, or any permutation thereof, either alone or in combination with the computer-implemented method of claim 28, representing generated musical content, and the computer-implemented method of claim 30, wherein the media content comprises synthesized audio waveforms.

30. The computer-implemented method of claim 19, wherein available media content that is available to the mobile device comprises artificially generated soundscape content generated by the processing device further comprising:
receiving a plurality of definitions of a plurality of distances;
determining that the mobile device is within the threshold distance from at least one reference location of the plurality reference locations;
determining that the mobile device is within the threshold range from at least one motion range of the plurality of motion ranges;
receiving one or a plurality of definitions of soundscape style, the definition comprising sound source selection, integration of actual sounds that exist in the environment surrounding the mobile device, reactive content based on items that exist in or visual views of the environment surrounding the mobile device, spatialization, dynamic range, frequency spectrum, density and texture, temporal structure, morphology, sonic signature, emotional and storytelling criteria, processing and modulation, cultural and symbolic referenced, spatialization techniques;
generating the soundscape content by applying one or a plurality of artificial intelligence techniques as a function of parameters selected from a parameter group consisting of a soundscape style specification, a route definition, and current sensor data provided by sensors embedded in the mobile device or by sensors connected wirelessly or through cabling to the mobile device;
generating media content from the mobile device to represent the soundscape composition, or any permutation thereof, either alone or in combination with the computer-implemented method of claim 28, representing generated musical content, and the computer-implemented method of claim 29, representing generated narrative spoken word content, wherein the media content comprises synthesized audio waveforms.

31. The computer-implemented method of claim 19, wherein the variation condition includes one or a plurality of the following parameters: a weather parameter, a round-trip status parameter, a day of the week parameter, or a time-of-day parameter.

32. A computer-implemented method of providing media content through a mobile device, comprising:
determining a temporal condition comprising:
receiving a definition of a temporal event, the definition comprising a name definition and a time definition;
determining that the mobile device is greater than, equal to, or less than a threshold time from a reference temporal parameter;
receiving a definition of a journey, the definition comprising a collection of temporal events;
determining a destination definition comprising:
receiving a definition of a journey destination, the definition comprising a name definition, a geographical definition, and a destination payload definition;
determining that the mobile device is greater than, equal to, or less than a threshold estimated time of arrival at the geographical definition;
determining that the destination has a payload comprising:
one or a plurality of payload items such as, but not limited to: specific media content, a spoken word announcement, an advertisement or informational Uniform Resource Locator (“URL”) or information packet provided by a destination business or individual for announcing, playing back, or displaying within the tool, or contact information for a resident of the destination for communicating, further comprising: a phone number or email for sending a pre-arrival text message, or a version of the tool installed on their phone which may provide messaging or other corresponding local media content actions;
selecting media content or performing communication activities as a function of the destination condition and its payload comprising;
media content that is selected to be played regardless of its duration, or media content that begins playback at a threshold time that is equal to its media duration such that the content playback is completed prior to the estimated arrival time at the destination;
determining whether a variation condition is met and executing an action in case the variation condition is met, wherein the executing comprises triggering an alternate action that takes priority over a default action in case one or a plurality of variation conditions other than the temporal condition are met;
selecting media content as a function of the variation condition, wherein the variation condition includes identifying parameters related to a journey;
selecting media content from available media content that is available to the processing device based on the determining that the processing device is greater than, equal to, or less than the threshold time and determining that the variation condition is met, the selected media content being associated with the name definition or the time definition;
queuing the selected media content for playback on the mobile device in a media queue, the media queue comprising a travel parameter; and
presenting media content from the media queue through the mobile device based on the travel parameter.

33. The computer-implemented method of claim 32, wherein the name definition is based on user data or media data, and wherein the temporal event definition comprises:
a temporal parameter definition, the definition comprising one or a plurality of parameters, the parameters further comprising: time of day, or time elapsed since or time until a reference temporal parameter;
a reference definition, the definition comprising temporal relationships of a journey, the relationships further comprising: time elapsed since beginning travel, repeating time during the journey, estimated time of arrival at an expected waypoint during the journey, and estimated time of arrival at the expected destination.

34. The computer-implemented method of claim 32, wherein determining that the mobile device is within the threshold time comprises receiving time data for the mobile device.

35. The computer-implemented method of claim 34, wherein the time data comprises time of day data, elapsed time data, or estimated time until a reference temporal definition.

36. The computer-implemented method of claim 32, wherein determining that the mobile device is within the threshold time comprises receiving time data for the mobile device.

37. The computer-implemented method of claim 32, wherein selecting the media content comprises:
identifying a playback action associated with the name definition and the temporal definition;
searching available media content based on the playback action; and selecting the media content based on the playback action.

38. The computer-implemented method of claim 32, wherein the playback action comprises at least one of playback of a single piece of media content, playback of a sequence of pieces of media content, and playback of at least a portion of an external stream of media content.

39. The computer-implemented method of claim 32, wherein available media content that is available to the mobile device comprises media content stored on the mobile device, external streams of media content accessible to the mobile device, and artificially generated compositions of media content generated locally by the mobile device or by an external processing system such as an internet-based server.

40. The computer-implemented method of claim 32, further comprising:
receiving a plurality of definitions of a plurality of times;
determining that the mobile device is within a threshold time from at least one reference temporal parameter of the plurality of reference temporal parameters;
selecting media content from available media content that is available to the mobile device based on the determining; and
queuing the selected media content for playback on the mobile device in the media queue.

41. The computer-implemented method of claim 32, wherein available media content that is available to the mobile device comprises artificially generated compositions of musical media content generated by the processing device further comprising:
receiving a plurality of definitions of a plurality of times;
determining that the mobile device is within a threshold time from at least one reference temporal parameter of the plurality of reference temporal parameters;
receiving one or a plurality of definitions of musical style, the definition comprising music genre, composer, artist, performer, instrumentation, orchestration, tempo, dynamics, melodic complexity, harmonic language, rhythmic character, texture, expressive elements, or melodic and harmonic tropes;
generating the musical media content by applying one or a plurality of artificial intelligence techniques as a function of parameters selected from a parameter group consisting of a musical style specification, a route definition, and current sensor data provided by sensors embedded in the mobile device or by sensors connected wirelessly or through cabling to the mobile device;
generating media content from the mobile device to represent the musical composition, or any permutation thereof, either alone or in combination with the computer-implemented method of claim 42 and the computer-implemented method of claim 43, wherein the media content comprises synthesized audio waveforms.

42. The computer-implemented method of claim 32, wherein available media content that is available to the mobile device comprises artificially generated spoken words of narrative content generated by the processing device further comprising:
receiving a plurality of definitions of a plurality of times;
determining that the mobile device is within the threshold time from at least one reference temporal parameter of the reference temporal parameters;
receiving one or a plurality of definitions of narrative style, the definition comprising fiction, nonfiction, age rating, language, narrative perspective, sentence structure, vocabulary and diction, tone and mood, setting and imagery, descriptive detail, dialogue style, characterization techniques, plot structure, themes and motifs, narrative voice, symbolism and allegory, irony and satire, rhetorical devices, narrative devices, structural innovations, voice playback parameters, weather conditions, user preferences, and narrative purpose further comprising: general storytelling, interactive conversation, education, information, inspiration, historical, or calming;
generating the narrative content by applying one or a plurality of artificial intelligence techniques as a function of parameters selected from a parameter group consisting of a narrative style specification, a narrative purpose definition, a route definition, and current sensor data from the mobile device or from devices connected wirelessly or through cabling to the mobile device;
generating media content from the mobile device to represent the narrative spoken word composition, or any permutation thereof, either alone or in combination with the computer-implemented method of claim 41, representing generated musical content, and the computer-implemented method of claim 43, wherein the media content comprises synthesized audio waveforms.

43. The computer-implemented method of claim 32, wherein available media content that is available to the mobile device comprises artificially generated soundscape content generated by the processing device further comprising:
receiving a plurality of definitions of a plurality of times;
determining that the mobile device is within the threshold distance from at least one reference temporal parameter of the plurality reference temporal parameters;
receiving one or a plurality of definitions of soundscape style, the definition comprising sound source selection, integration of actual sounds that exist in the physical area surrounding the mobile device, reactive content based on items that exist in or visual views of the environment surrounding the mobile device, spatialization, dynamic range, frequency spectrum, density and texture, temporal structure, morphology, sonic signature, emotional and storytelling criteria, processing and modulation, cultural and symbolic referenced, spatialization techniques;
generating the soundscape content by applying one or a plurality of artificial intelligence techniques as a function of parameters selected from a parameter group consisting of a soundscape style specification, a route definition, and current sensor data provided by sensors embedded in the mobile device or by sensors connected wirelessly or through cabling to the mobile device;
generating media content from the mobile device to represent the soundscape composition, or any permutation thereof, either alone or in combination with the computer-implemented method of claim 41, representing generated musical content, and the computer-implemented method of claim 42, representing generated narrative spoken word content, wherein the media content comprises synthesized audio waveforms.

44. The computer-implemented method of claim 32, wherein the variation condition includes one or a plurality of the following parameters: a weather parameter, a round-trip status parameter, a day of the week parameter, or a time-of-day parameter.

45. A computer-implemented method of providing media content through a mobile device, comprising:
determining a wellness condition comprising:
receiving a definition of a wellness event, the definition comprising a name definition and a measured wellness definition, an assessed wellness definition, a target wellness condition, and a media content playback metric definition;
receiving a measured wellness definition, the definition comprising data from one or a plurality of sensors representing user mood, state of mind, level of anxiety, or overall emotional state;
receiving a reported wellness definition, the definition comprising: information on user personal aspects including, but not limited to, likes, dislikes, anxieties, irritants, triggers, gratitude's, desires, worries, pleasures, comforts, gathered by manual entry by the user directly within the tool on the mobile device or from an internet-based server that is directly related to and wholly a part of this invention, or gathered by a conversational natural language interface between the tool and the user;
receiving a target wellness definition, the definition comprising: target values for the information provided by the measured wellness definition and the assessed wellness definition;
receiving a definition of media content playback metrics, the definition comprising a quantity of times a specific media selection or a specific type of media content has been played and completed for the user during a time period, and a total amount of playback time that a specific media selection or a specific type of media content has been playing for the user during a time period, the time period further comprising: the current day, the current week, the current month, during the currently playing session, or since the app was installed;
determining whether a target wellness definition is within a threshold range and executing an action in case the target wellness condition is met, wherein the executing comprises triggering a default action;
receiving a definition of a journey, the definition comprising a collection of wellness events;
capturing the measured, reported, and target wellness conditions and utilizing them for future content suggestions or content parameter alterations;
determining a location condition comprising:
receiving a definition of a route of travel, the definition comprising a name definition, a geographical definition, and a motion definition;
determining that the mobile device is within a threshold distance from the route of travel and is traveling in accordance with the current route of travel and the projected route of travel trajectory;
receiving a definition of motion, the definition comprising data from one or a plurality of sensors representing speed, acceleration, and bearing;
determining that the mobile device is traveling within a threshold range of the motion definition;
receiving a definition of a journey, the definition comprising a collection of routes;
selecting media content as a function of the target wellness condition, wherein the wellness condition includes identifying parameters related to a journey;
determining whether a variation condition is met and executing an action in case the variation condition is met, wherein the executing comprises triggering an alternate action that takes priority over a default action in case one or a plurality of variation conditions other than the wellness condition are met;
selecting media content as a function of the variation condition, wherein the variation condition includes identifying parameters related to a journey;
selecting media content from available media content that is available to the processing device based on the determining that the processing device is within the threshold range and determining that the variation condition is met, the selected media content being associated with the name definition or the time definition;
queuing the selected media content for playback on the mobile device in a media queue, the media queue comprising a travel parameter; and
presenting media content from the media queue through the mobile device based on the travel parameter.

46. The computer-implemented method of claim 45, wherein the name definition is based on user data or media data, and wherein the wellness event definition comprises:
a wellness parameter definition, the definition comprising one or a plurality of parameters, the parameters further comprising anxiety level, physiological stress level, or overall emotional state;
a wellness reference definition, the definition comprising target values for one or a plurality of sensor data sources.

47. The computer-implemented method of claim 45, wherein determining that the mobile device is within the threshold range comprises receiving sensor data for the mobile device.

48. The computer-implemented method of claim 47, wherein the sensor data comprises blood pressure, heart rate, electrodermal activity (EDA), electroencephalography (EEG), respiration rate, user voice analysis, eye-tracking activity, visual fixation points, or temperature sensors.

49. The computer-implemented method of claim 45, wherein determining that the mobile device is within the threshold range comprises receiving sensor data from the mobile device.

50. The computer-implemented method of claim 45, wherein selecting the media content comprises:
identifying a playback action associated with the name definition and the wellness definition;
searching available media content based on the playback action; and selecting the media content based on the playback action.

51. The computer-implemented method of claim 45, wherein the playback action comprises at least one of playback of a single piece of media content, playback of a sequence of pieces of media content, and playback of at least a portion of an external stream of media content.

52. The computer-implemented method of claim 45, wherein available media content that is available to the mobile device comprises media content stored on the mobile device, external streams of media content accessible to the mobile device, and artificially generated compositions of media content generated locally by the mobile device or by an external processing system such as an internet-based server.

53. The computer-implemented method of claim 45, further comprising:
receiving a plurality of definitions of a plurality of wellness parameters;
determining that the mobile device is within a threshold range of at least one target wellness condition of the plurality of target wellness conditions;
selecting media content from available media content that is available to the mobile device based on the determining; and
queuing the selected media content for playback on the mobile device in the media queue.

54. The computer-implemented method of claim 45, wherein available media content that is available to the mobile device comprises artificially generated compositions of musical media content generated by the processing device further comprising:
receiving a plurality of definitions of a plurality of wellness parameters;
determining that the mobile device is within a threshold range of at least one target wellness parameter of the plurality of target wellness parameters;
receiving one or a plurality of definitions of musical style, the definition comprising music genre, composer, artist, performer, instrumentation, orchestration, tempo, dynamics, melodic complexity, harmonic language, rhythmic character, texture, expressive elements, or melodic and harmonic tropes;
generating the musical media content by applying one or a plurality of artificial intelligence techniques as a function of parameters selected from a parameter group consisting of a musical style specification, a route definition, and current sensor data provided by sensors embedded in the mobile device or by sensors connected wirelessly or through cabling to the mobile device;
generating media content from the mobile device to represent the musical composition, or any permutation thereof, either alone or in combination with the computer-implemented method of claim 55 and the computer-implemented method of claim 56, wherein the media content comprises synthesized audio waveforms.

55. The computer-implemented method of claim 45, wherein available media content that is available to the mobile device comprises artificially generated spoken words of narrative content generated by the processing device further comprising:
receiving a plurality of definitions of a plurality of wellness parameters;
determining that the mobile device is within a threshold range of at least one target wellness parameter of the target wellness parameters;
receiving one or a plurality of definitions of narrative style, the definition comprising fiction, nonfiction, age rating, language, narrative perspective, sentence structure, vocabulary and diction, tone and mood, setting and imagery, descriptive detail, dialogue style, characterization techniques, plot structure, themes and motifs, narrative voice, symbolism and allegory, irony and satire, rhetorical devices, narrative devices, structural innovations, voice playback parameters, weather conditions, user preferences, and narrative purpose further comprising: general storytelling, interactive conversation, education, information, inspiration, or calming;
generating the narrative content by applying one or a plurality of artificial intelligence techniques as a function of parameters selected from a parameter group consisting of a narrative style specification, a narrative purpose definition, a route definition, and current sensor data from the mobile device or from devices connected wirelessly or through cabling to the mobile device;
generating media content from the mobile device to represent the narrative spoken word composition, or any permutation thereof, either alone or in combination with the computer-implemented method of claim 54 representing generated musical content, and the computer-implemented method of claim 56, wherein the media content comprises synthesized audio waveforms.

56. The computer-implemented method of claim 45, wherein available media content that is available to the mobile device comprises artificially generated soundscape content generated by the processing device further comprising:
receiving a plurality of definitions of a plurality of wellness parameters;
determining that the mobile device is within a threshold range of at least one target wellness condition of the plurality of target wellness conditions;
receiving one or a plurality of definitions of soundscape style, the definition comprising sound source selection, integration of actual sounds that exist in the environment surrounding the mobile device, reactive content based on items that exist in or visual views of the environment surrounding the mobile device, spatialization, dynamic range, frequency spectrum, density and texture, temporal structure, morphology, sonic signature, emotional and storytelling criteria, processing and modulation, cultural and symbolic referenced, spatialization techniques;
generating the soundscape content by applying one or a plurality of artificial intelligence techniques as a function of parameters selected from a parameter group consisting of a soundscape style specification, a route definition, and current sensor data provided by sensors embedded in from the mobile device or by sensors connected wirelessly or through cabling to the mobile device;
generating media content from the mobile device to represent the soundscape composition, or any permutation thereof, either alone or in combination with the computer-implemented method of claim 54, representing generated musical content, and the computer-implemented method of claim 55, representing generated narrative spoken word content, wherein the media content comprises synthesized audio waveforms.

57. The computer-implemented method of claim 45, wherein the variation condition includes one or a plurality of the following parameters: a weather parameter, a round-trip status parameter, a day of the week parameter, or a time-of-day parameter.
